(19) United States
(12) Patent Application Publication
(10) Pub. No.: US 2014/0222570 A1
(43) Pub. Date: Aug. 7, 2014

(54) System, Method, and Computer Program Product For Probabilistically Derived Predictive Location Based Targeted Promotion

(71) Applicant: Teoco Corporation, Fairfax, VA (US)

(72) Inventors: John A. DEVOLITES, Oakton, VA (US); David Corley, Fairfax, VA (US)

(73) Assignee: Teoco Corporation, Fairfax, VA (US)

(21) Appl. No.: 14/082,101

(22) Filed: Nov. 15, 2013

Related U.S. Application Data
(60) Provisional application No. 61/727,668, filed on Nov. 17, 2012.

(51) Int. Cl. G06Q 30/02; H04W 8/18; H04W 4/02

(52) U.S. Cl. CPC G06Q 30/0261; G06Q 30/0267; H04W 4/02; H04W 8/18
USPC 705/14.58; 455/456.1

(57) ABSTRACT

An exemplary system, method, and/or computer program product may programmatically by computer processor(s) combine various exemplary data elements to create an analyzed and calculated predictive device location, categorized by time of day for one or more devices. The exemplary method may take in as input(s) exemplary passive data that results from geolocated communication events such as wireless voice calls, data sessions and/or wireless communications tower or network hotspot information. The inputs, according to an embodiment may be combined and enriched with exemplary Latitude/Longitude reference data to provide a location history for an exemplary device. Based on analysis of frequented locations and time periods, the detailed location history information for a device may be probability weighted (e.g., scored) to predict where the device will be, at a given future time, based on the given device's detailed location history, and exemplary time of day, e.g., morning, afternoon, night, etc. The information may be used to create targeted campaigns based on an predicted device location.

### CROSS REFERENCE TO RELATED APPLICATIONS

The present invention is a US NonProvisional Patent Application, which claims the benefit under 35 U.S.C. Section 119(e) of U.S. Provisional Patent Application No. 61/727,668, filed Nov. 17, 2012, entitled, “System, Method, and Computer Program Product For Probabilistically Derived Predictive Location Based Targeted Promotion,” the contents of which is incorporated herein by reference in its entirety.

### BACKGROUND OF THE INVENTION

1. Field of the Invention

The present invention relates to communications networks generally, and more particularly to location based applications, and more particularly targeted location based applications.

2. Discussion of the Related Art

Location-based services (LBS) are a general class of computer program-level services used to include specific controls for location and time data as control features in computer programs. As such has a number of uses in Social Networking today as an entertainment service, which is accessible with mobile devices through the mobile network and which uses information on the geographical position of the mobile device. LBS has become more important with the advent of portable devices including smartphones and tablet computing. LBS are used in health, indoor object search, entertainment, work life, etc.

LBS include services to identify a current location of a person or object, such as discovering the nearest banking cash machine or the whereabouts of a friend or employee. LBS include parcel tracking and vehicle tracking services. LBS can include mobile commerce when taking the form of coupons or advertising directed at customers based on their current location.

Conventionally, location based systems (LBS) provide services based on where a person's location is determined to be at the present time period (e.g., in a restaurant, at a given address). Additionally, subscribers must opt-in and have a location sensing system, such as, e.g., but not limited to, global positioning system (GPS) activated, turned on, and opted in, for conventional geographic targeting methods to work.

Conventional systems have various shortcomings. It would be desirable to overcome shortcomings of conventional solutions.

### SUMMARY OF THE INVENTION

Accordingly, the present invention is directed to a call, IP flow, or session tracking system, method and/or computer program product that overcomes one or more of the shortcomings of conventional solutions, due to limitations and disadvantages of the related art.

A system, method, computer program product and computer processor-implemented method of analyzing measurement data may include a computer-implemented method, which may include a) receiving or collecting, by at least one processor, at least one call detail record information comprising at least one of: i) at least one communications tower location information; ii) at least one voice call detail records (CDRs); or iii) at least one data CDRs; b) determining historic precise location information for each of a plurality of devices of a communications service provider (CSP), said determining comprising: i) analyzing said historic precise location information of said each of said plurality of devices by geolocation; ii) analyzing at least one cluster of said historic precise location information; or iii) analyzing at least one time range for said each of said given clusters of said historic precise location information; and c) predicting probabilistically at least one expected future precise location and at least one expected time period for said each of said plurality of devices.

An exemplary embodiment of the method may further include where comprising at least one of: d) targeting at least one offering based on said predicting; e) providing at least one offering to said at least one given device based on said predicting; or f) monetizing at least one offering based on said predicting.

The method according to claim 2, wherein said at least one offering comprises at least one of: a promotion, a coupon, an advertisement, a time based offering, a voucher, a discount, an electronic message, electronic mail (email), facsimile (fax), a simple message system (SMS), a multimedia message system (MMS), a gift certificate, an expiring deal, a daily deal, a group coupon, a Groupon offer, a LivingSocial offer, an electronic commerce offering, an Amazon offer, a social network communication, a social media post, a tweet, a Facebook post, a Pinterest pin, a bricks and mortar offering, a traditional coupon, or a targeted promotion.

An exemplary embodiment of the method may include where said communications service provider comprises at least one of: a wireless communications service provider; or a global communications service provider.

An exemplary embodiment of the method may include where said analyzing said at least one cluster comprises analyzing and identifying a probability of a cluster comprising at least one of: at least one home; at least one work; at least one vacation home; at least one school; at least one geographic region; at least one county, city, town, village, or municipality; at least one road; at least one path; at least one series of directions taken; at least one block; or at least one building.

An exemplary embodiment of the method may include where said analyzing said at least one time range comprises analyzing at least one of: at least one start time; at least one end time; or at least one duration.

An exemplary embodiment of the method may include where said probabilistically predicting of said (c) comprises predicting at least one of: at least one expected behavior; at least one expected path to be taken; at least one expected action; at least one expected desire; at least one expected need; at least one expected behavior; or at least one expected next location for the said each given device.

An exemplary embodiment of the method may include where said communications tower location information of (a) (i) comprises at least one of: detailed call detail record (CDR) data; simple message system (SMS) record data; data session record data; wireless network data; wireless fidelity (WiFi) hotspot measurement data; measurement data from a radio access network (RAN); per call measurement data; data measuring relative strength of tower communication before, during and after a call; or a device's location based information.

An exemplary embodiment of the method may further include where, generating a target subscriber list for at least one campaign; or providing a subscriber list to a carrier for delivery of at least one of an offer, content, or an advertisement.

An exemplary embodiment of the method may include a computer implemented method comprising: a) collecting, by at least one computer processor, at least one event record of at least one event from at least one carrier network, wherein said at least one event record comprises at least one of: at least one call detail record (CDR) from a switch; at least one simple message system (SMS) record from a switch; at least one data session record from an authentication server; at least one measurement data from a wireless network; or at least one measurement data from a radio access network (RAN); b) calculating at least one location for each of said at least one event, wherein said calculating said at least one location of said at least one event comprises at least one of looking up at least one serving communication tower location; geolocating said at least one event; or applying at least one geolocation algorithm to said at least one measurement data, comprising at least one of: triangulating; converting measurement data to location data; determining a center and surrounding radius of a location; c) storing at least a predefined number of days of at least one located event data comprising said at least one event and said at least one location in at least one data repository; and d) calculating and store at least one frequented location for each subscriber.

An exemplary embodiment of the method may include where said storing of said predefined number of days of said (c) comprises at least one of: storing at least 60 days of said at least one located event data; storing at least a week of said at least one located event data; or storing at least two weeks of said at least one located event data; storing at least two or more weeks of said at least one located event data.

An exemplary embodiment of the method may include where said calculating of said (d) comprises at least one of: calculating periodically said at least one frequented location for each subscriber; or using a cluster analysis to group located events and identify said at least one frequented location, wherein said cluster analysis comprises at least one of: determining a center location of a cluster; determining an area about a cluster location; or calculating and storing at least one predicted day of week and time of day range for each of said at least one frequented location for each subscriber; or calculating and storing at least one location score that represents a probability of a subscriber being in a given one of said at least one frequented location during a typical date and time period, wherein said probability comprises at least one of: statistical analysis; calculating a score; calculating a mean and standard deviation; or probability analysis.

An exemplary embodiment of the method may further include where generating a target subscriber list for at least one specific ad campaign.

An exemplary embodiment of the method may include where said generating comprises at least one of: at least one ad campaign specified based on at least one of: at least one predicted location of the subscriber; at least one location score of the subscriber; or one subscriber demographic information provided by the carrier.

An exemplary embodiment of the method may include where said at least one subscriber demographic data comprises at least one of: a gender; or an age.

An exemplary embodiment of the method may further include where the method may include providing said target subscriber list to the at least one carrier for delivery of at least one of: at least one ad; or at least one offer.

An exemplary embodiment of the method may include where at least one of: said subscriber information of subscribers on said subscriber list is not exposed to an advertiser; or said information is maintained in private.

An exemplary embodiment of the system may include: at least one memory; at least one processor coupled to said at least one memory, said processor adapted to collect at least one event record of at least one event from at least one carrier network, wherein said at least one event record comprises at least one of: at least one call detail record (CDR) from a switch; at least one simple message system (SMS) record from a switch; at least one data session record from an authentication server; at least one measurement data from a wireless network; or at least one measurement data from a radio access network (RAN); said processor adapted to calculate at least one location for each of said at least one event, wherein said calculation of said at least one location of said at least one event comprises at least one of: the processor adapted to look up at least one serving communication tower location; the processor adapted to geolocate said at least one event; or the processor adapted to apply at least one geolocation algorithm to said at least one measurement data, comprising at least one of: the processor adapted to triangulate; the processor adapted to convert measurement data to location data; the processor adapted to determine a center and surrounding radius of a location; the processor adapted to store at least a predefined number of days of at least one located event data comprising said at least one event and said at least one location in at least one data repository; and the processor adapted to calculate and store at least one frequented location for each subscriber.

A nontransitory computer program product embodied on a computer readable medium, said computer program product comprising program logic, which when executed on a processor may execute a method may include, in an exemplary embodiment: a) collecting at least one event record of at least one event from at least one carrier network, wherein said at least one event record comprises at least one of: at least one call detail record (CDR) from a switch; at least one simple message system (SMS) record from a switch; at least one data session record from an authentication server; at least one measurement data from a wireless network; or at least one measurement data from a radio access network (RAN); b) calculating at least one location for each of said at least one event, wherein said calculating said at least one location of said at least one event comprises at least one of: looking up at least one serving communication tower location; geolocating said at least one event; or applying at least one geolocation algorithm to said at least one measurement data, comprising at least one of: triangulating; converting measurement data to location data; determining a center and surrounding radius of a location; c) storing at least a predefined number of days of at least one located event data comprising said at least one event and said at least one location in at least one data repository; and d) calculating and store at least one frequented location for each subscriber.

A system, method, computer program product and computer processor-implemented method of analyzing even data may include, an exemplary computer-implemented method, which may include, but may not be limited to: a) receiving or collecting, by at least one processor, at least one geolocated subscriber event data; wherein the geolocated subscriber event data may include at least one of: i) at least one the geolocated subscriber event data derived from at least one communications tower location information; ii) at least one the geolocated subscriber event data derived from at least one call detail record (CDR) data; or iii) at least one the geolocated subscriber event data from at least one global positioning system sensor (GPS); b) determining historic location information for each of a plurality of devices of a communications service provider (CSP), the determining may include: i) receiving the historic location information of the each of the plurality of devices by geolocation; ii) identifying at least one frequented location of at least one subscriber based on of the historic location information; and iii) determining at least one time range for the each of the at least one frequented location of the historic location information; and c) predicting probabilistically at least one expected location and at least one expected time period for the each of the plurality of devices.

According to an exemplary embodiment, the method may further include at least one of: d) targeting at least one offering based on the predicting; e) providing at least one offering to the at least one given device based on the predicting; or f) monetizing at least one offering based on the predicting.

According to an exemplary embodiment, the method may include where the at least one offering may include at least one of: a promotion, a coupon, an advertisement, a time based offering, a voucher, a discount, an electronic message, electronic mail (email), facsimile (fax), a simple message system (SMS), a multimedia message system (MMS), a gift certificate, an expiring deal, a daily deal, a group coupon, a Groupon offer, a LivingSocial offer, an electronic commerce offering, an Amazon offer, a social network communication, a social media post, a tweet, a Facebook post, a Pinterest pin, a bricks and mortar offering, a traditional coupon, or a targeted promotion.

According to an exemplary embodiment, the method may include where the communications service provider may include at least one of: a wireless communications service provider; or a global communications service provider.

According to an exemplary embodiment, the method may include where the analyzing the at least one cluster may include analyzing and identifying a probability of a cluster may include at least one of: at least one home; at least one work; at least one vacation home; at least one school; at least one geographic region; at least one county, city, town, village, or municipality; at least one road; at least one path; at least one series of directions taken; at least one block; or at least one building.

According to an exemplary embodiment, the method may include where the analyzing the at least one time range may include analyzing at least one of: at least one start time; at least one end time; or at least one duration.

According to an exemplary embodiment, the method may include where the probabilistically predicting of the (c) may include predicting at least one of: at least one expected behavior; at least one expected path to be taken; at least one expected action; at least one expected desire; at least one expected need; at least one expected behavior; or at least one expected next location for the each given device.

According to an exemplary embodiment, the method may include where the communications tower location information of (a) (i) may include at least one of: detailed call detail record (CDR) data; simple message system (SMS) record data; data session record data; wireless network data; wireless fidelity (WiFi) hotspot measurement data; measurement data from a radio access network (RAN); per call measurement data; data analyzing relative strength of tower communication before, during and after a call; or a device's location based information.

According to an exemplary embodiment, the method may further include where the at least one of: generating a target subscriber list for at least one campaign; or providing a subscriber list to a carrier for delivery of at least one of an offer, content, or an advertisement.

According to an exemplary embodiment, an exemplary embodiment of the method may include, e.g., but not limited to, a) collecting, by at least one computer processor, at least one event record of at least one event from at least one carrier network, wherein the at least one event record may include at least one of: at least one call detail record (CDR) from a switch; at least one simple message system (SMS) record from a switch; at least one data session record from an authentication server; at least one the geolocated subscriber event data from at least one global positioning system sensor (GPS); at least one measurement data from a wireless network; or at least one measurement data from a radio access network (RAN); b) calculating at least one location for each of the at least one event, wherein the calculating the at least one location of the at least one event may include at least one of: looking up at least one serving communication tower location; geolocating the at least one event; or applying at least one geolocation algorithm to the at least one measurement data, may include at least one of: triangulating; converting measurement data to location data; determining a center and surrounding radius of a location; c) storing at least a predefined number of days of at least one located event data may include the at least one event and the at least one location in at least one data repository; and d) calculating and storing at least one frequented location for each subscriber.

According to an exemplary embodiment, the method may include where the storing of the predefined number of days of the (c) may include at least one of: storing at least 60 days or at least 90 days of the at least one located event data; storing at least a week of the at least one located event data; storing at least two weeks of the at least one located event data; or storing at least two or more weeks of the at least one located event data.

According to an exemplary embodiment, the method may include where the calculating of the (d) may include at least one of: calculating periodically the at least one frequented location for each subscriber; or using a cluster analysis to group located events and identify the at least one frequented location, wherein the cluster analysis may include at least one of: determining a center location of a cluster; determining an area about a cluster location; or determining a radius about a cluster.

According to an exemplary embodiment, the method may include where the calculating of the (d) may include at least one of: calculating and storing at least one predicted day of week and time of day range for each of the at least one frequented location for each subscriber; or calculating and storing at least one location score that represents a probability of a subscriber being in a given one of the at least one frequented location during a typical date and time period, wherein the probability may include at least one of: statistical analysis; calculating a score; calculating a mean and standard deviation; or probability analysis.

According to an exemplary embodiment, the method may further include generating a target subscriber list for at least one specific ad campaign.

According to an exemplary embodiment, the method may include where the generating may include at least one of: at least one ad campaign specified based on at least one of: at least one predicted location of the subscriber; at least one location score of the subscriber; or at least one subscriber demographic information provided by the carrier.

According to an exemplary embodiment, the method may include where the at least one subscriber demographic data may include at least one of: a gender; or an age.

According to an exemplary embodiment, the method may further include providing the target subscriber list to the at least one carrier for delivery of at least one of: at least one communication; at least one ad; at least one notification; at least one alert; at least one promotion; at least one coupon; or at least one offer.

According to an exemplary embodiment, the method may include at least one of: the subscriber information of subscribers on the subscriber list is not exposed to an advertiser; or the information is maintained in private.

According to another exemplary embodiment, an exemplary system may include, e.g., but may not be limited to, at least one memory; at least one processor coupled to the at least one memory, the processor adapted to collect at least one event record of at least one event from at least one carrier network, wherein the at least one event record may include at least one of: at least one call detail record (CDR) from a switch; at least one simple message system (SMS) record from a switch; at least one data session record from an authentication server; at least one global positioning system (GPS) location; at least one measurement data from a wireless network; or at least one measurement data from a radio access network (RAN); the processor adapted to calculate at least one location for each of the at least one event, wherein the calculation of the at least one location of the at least one event may include at least one of: the processor adapted to look up at least one serving communication tower location; the processor adapted to geolocate the at least one event; or the processor adapted to apply at least one geolocation algorithm to the at least one measurement data, may include at least one of: the processor adapted to triangulate; the processor adapted to convert measurement data to location data; the processor adapted to determine a center and surrounding radius of a location; the processor adapted to store at least a predefined number of days of at least one located event data may include the at least one event and the at least one location in at least one data repository; and the processor adapted to calculate and store at least one frequented location for each subscriber.

According to an exemplary embodiment, an exemplary nontransitory computer program product embodied on a computer readable medium, where the computer program product may include program logic, which when executed on a processor may execute a method, which may include, e.g., but may not be limited to: a) collecting at least one event record of at least one event from at least one carrier network, wherein the at least one event record may include at least one of: at least one call detail record (CDR) from a switch; at least one simple message system (SMS) record from a switch; at least one data session record from an authentication server; at least one location from a global positioning system (GPS); at least one measurement data from a wireless network; or at least one measurement data from a radio access network (RAN); b) calculating at least one location for each of the at least one event, wherein the calculating the at least one location of the at least one event may include at least one of: looking up at least one serving communication tower location; geolocating the at least one event; or applying at least one geolocation algorithm to the at least one measurement data, may include at least one of: triangulating; converting measurement data to location data; determining a center and surrounding radius of a location; c) storing at least a predefined number of days of at least one located event data may include the at least one event and the at least one location in at least one data repository; and d) calculating and storing at least one frequented location for each subscriber.

According to yet another exemplary embodiment, the method may include, e.g., but may not be limited to include a) receiving or collecting, by at least one processor, at least one geolocated event data for at least one subscriber; b) identifying, by the at least one processor, at least one frequented location of a given one of the at least one subscriber using the at least one geolocated event data; d) determining, by the at least one processor, at least one time period during which the given one of the at least one subscriber was at least one of entering, within or leaving at least one of the at least one frequented location; and e) predicting, by the at least one processor, for the given one of the at least one subscriber, at least one predicted location and at least one predicted time period; and f) providing, by the at least one processor, the at least one predicted location and the at least one predicted time period.

According to an exemplary embodiment, the method may include where the (b) of the identifying the at least one frequented location may include: receiving, by the at least one processor, a block size; receiving, by the at least one processor, a superblock size, wherein the superblock size is a multiple of the block size; creating, by the at least one processor, a grid whose cell size is the block size, wherein the grid covers an entire geographic area of the at least one the geolocated event data; determining, by the at least one processor, a number of at least one geolocated event in each and every one of the superblocks that aligns with or snaps to the grid and is completely contained in the grid; creating, by the at least one processor, a list of the at least one superblock with an associated one of the number of the at least one geolocated event; ordering, by the at least one processor, the list of the at least one superblock into an ordered list, in descending order by value of the associated one of the number of the at least one geolocated event; and eliminating, by the at least one processor, any of the at least one superblock of the ordered list of the at least one superblocks, that shares at least one block of another of the at least one superblock that is higher on the ordered list; and eliminating, by the at least one processor, any superblock of any remaining of the at least one superblocks that has a value of the associated one of the number of the at least one geolocated event, that falls below a threshold number of events.

According to an exemplary embodiment, the method may include where the geolocated event data may include at least one of: i) at least one the geolocated subscriber event data derived from at least one per call measurement data (PCMD); ii) at least one the geolocated subscriber event data derived from at least one call detail record (CDR) data; or iii) at least one the geolocated subscriber event data derived from at least one global positioning system (GPS) data.

It is to be understood that both the foregoing general description and the following detailed description are exemplary and explanatory and are intended to provide further explanation of the invention as claimed, but are not to be understood as limiting.

### BRIEF DESCRIPTION OF THE DRAWINGS

The accompanying drawings, which are included to provide a further understanding of the invention and are incorporated in and constitute a part of this specification, illustrate exemplary, and nonlimiting embodiments of the invention and together with the description serve to explain the principles of the invention.

In the drawings, like reference numbers indicate substantially similar, equivalent, or exemplary elements, and the left most digits in the corresponding reference number indicate the drawing in which an element first appears.

FIG. 1 illustrates an exemplary process flow chart illustrating an exemplary process of collecting geolocated event data, identifying frequented locations, determining time periods associated with the frequented locations, receiving any tags, and providing predictive data as to a future location and time range for a given subscriber, as well as optionally using the information to conduct a campaign(s), the according to an exemplary embodiment of the present invention;

FIG. 2 illustrates an exemplary diagram illustrating various exemplary location based historical data sources and exemplary processing according to an exemplary embodiment of the present invention;

FIG. 3 illustrates an exemplary flow chart depicting an exemplary process of identifying frequently visited locations by a given subscriber according to an exemplary embodiment of the present invention;

FIG. 4 illustrates an exemplary map showing a plurality of event data for a given subscriber according to an exemplary embodiment of the present invention;

FIG. 5 illustrates an exemplary blocked grid illustrating an exemplary block and superblock definition, according to an exemplary embodiment of the present invention;

FIG. 6 illustrates an exemplary process of identifying an exemplary cluster, which may include ordering superblocks by event frequency and removing lower ranked superblocks that overlap a higher ranked superblock, according to an exemplary embodiment of the present invention;

FIG. 7 illustrates an exemplary day of week by hour of day grid, which may be used to identify exemplary time periods for a first given exemplary cluster location, which may be used to identify starting and stopping times, and illustrating exemplary alert times relative to the exemplary starting, according to an exemplary embodiment;

FIG. 8 illustrates an exemplary day of week by hour of day grid, which may be used to identify exemplary time periods for a second given exemplary cluster location, which may be used to identify starting and stopping times, and illustrating exemplary alert times relative to the exemplary starting, according to an exemplary embodiment;

FIG. 9 illustrates an exemplary flow chart depicting an exemplary process of using the exemplary location based data and exemplary expected time periods to conduct an exemplary targeted campaign, according to an exemplary embodiment of the present invention; and

FIG. 10 illustrates an exemplary computer system as may be used in implementing an exemplary component of the system, according to an exemplary embodiment of the invention.

### DETAILED DESCRIPTION OF VARIOUS EXEMPLARY EMBODIMENTS

Reference will now be made in detail to various exemplary embodiments of the present invention, examples of which are illustrated in the accompanying drawings. A preferred exemplary embodiment of the invention is discussed in detail below. While specific exemplary embodiments are discussed, it should be understood that this is done for illustration purposes only. A person skilled in the relevant art will recognize that other components and configurations may be used without parting from the spirit and scope of the invention.

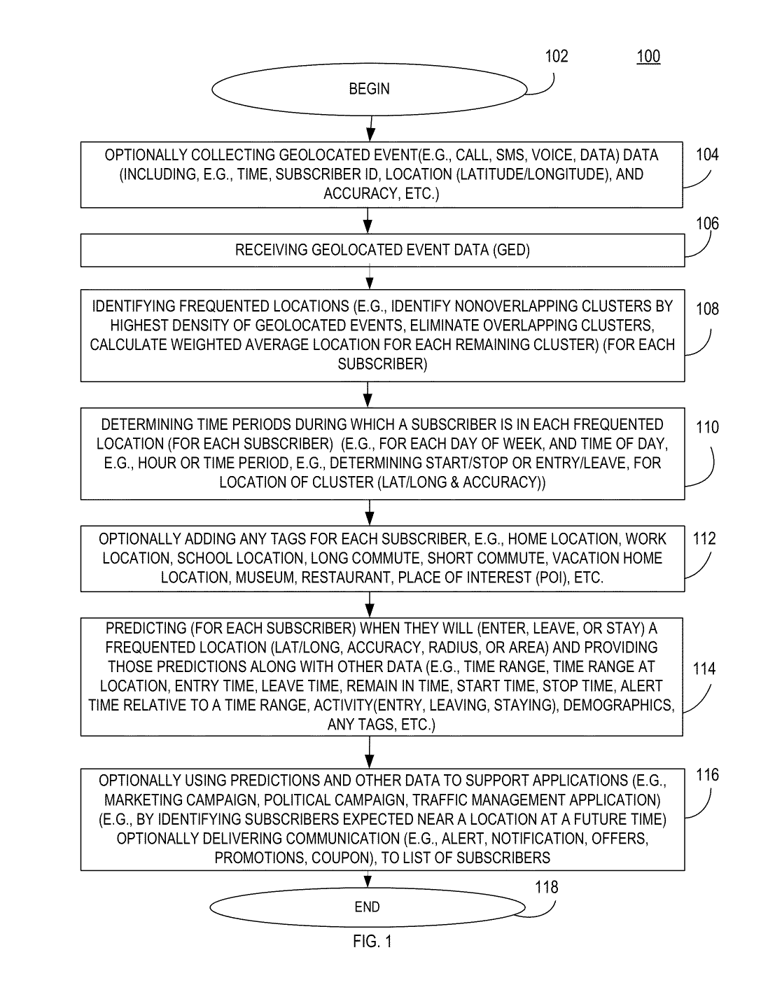

FIG. 1 illustrates an exemplary process flow chart 100 illustrating an exemplary process of collecting or receiving geolocated event data, identifying frequented locations, determining time periods associated with the frequented locations, optionally receiving any tags, and providing predictive data as to a future location and time range for a given subscriber, as well as optionally using the information to conduct a campaign(s), the according to an exemplary embodiment of the present invention.

Flow diagram 100 may begin with 102, and may continue immediately with 104, according to an exemplary embodiment.

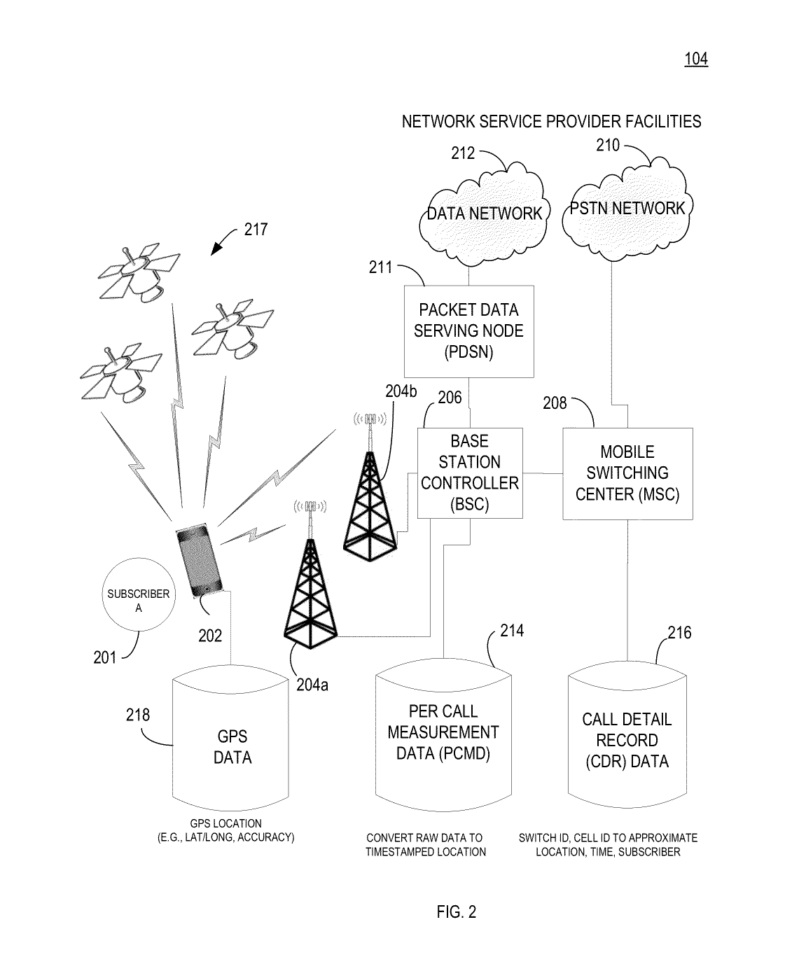

In 104, flow diagram 100 may optionally collect geolocated event data, such geolocated event data may include, e.g., but may not be limited to, a time, a subscriber identifier (ID), a location (e.g., in latitude and longitude, etc.), and/or accuracy, etc., according to an exemplary embodiment. According to an exemplary embodiment, an event may include, e.g., but not be limited to, a call, an SMS, a voice communication, a data communication, and/or other event, etc. In an exemplary embodiment, event data may be geolocated by, e.g., but not limited to, adding a location (such as, e.g., but not limited to, latitude, longitude, and/or accuracy, etc.), which may be associated with the location of the caller/called party, a subscriber referred to and discussed further in FIG. 2. The geolocated data may be graphed on a map, according to one exemplary embodiment. Various methods of collecting such geolocated event data (GED) are contemplated, as described further below with reference to FIG. 2, according to various exemplary embodiments. From 104, flow diagram 100 may proceed with 106.

In 106, flow diagram 100 may include receiving geolocated event data (GED), according to an exemplary embodiment. According to one exemplary embodiment, one entity may collect, aggregate, enhance by adding enrichments, etc., and may then provide such aggregate data to one or more other entities, which may receive the GED from the entity collecting, aggregating, and/or enriching the data. In another exemplary embodiment, the data may be both collected, as in 104, and may further be passed for further integrated processing as represented by 106 of exemplary flow diagram 100. From 106, flow diagram 100 may proceed with 108.

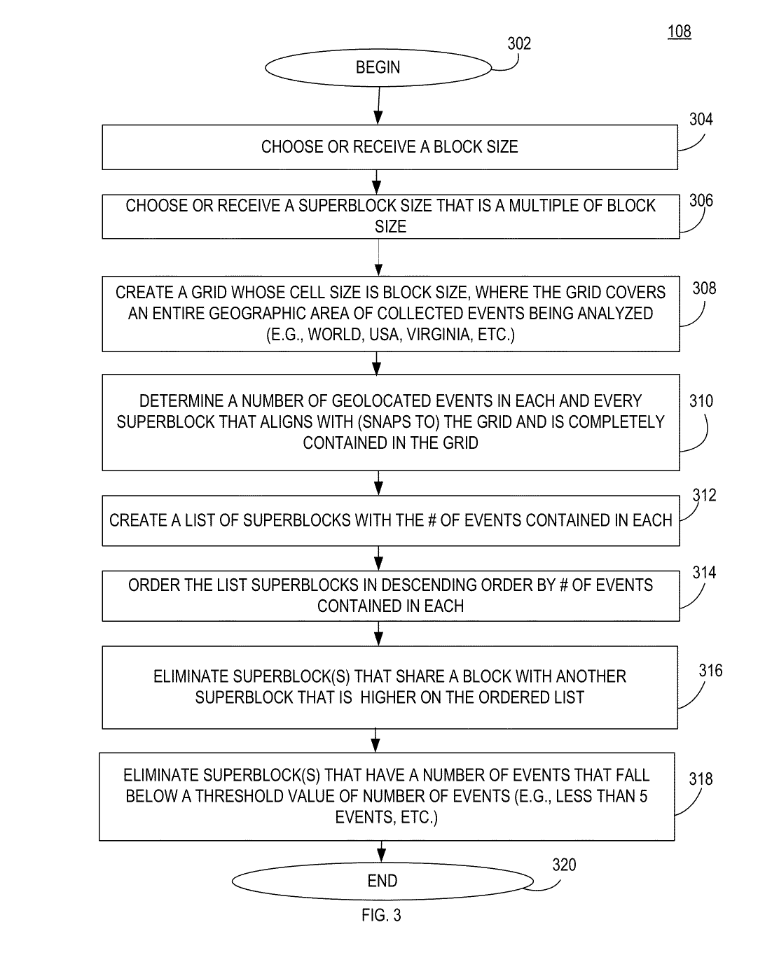

In 108, flow diagram 100 may identify (for each subscriber) one or more frequented locations, according to an exemplary embodiment. In one exemplary embodiment, the frequented location (e.g., may identify an exemplary nonoverlapping frequented locations, which may also be referred to as a cluster), according to an exemplary embodiment. In one exemplary embodiment, the frequented locations may be determined by further analysis, such as described further, below with reference to FIGS. 3-6. Various other ways may also be used to identify a frequented location, such as, e.g., but not limited to, based on the collected and/or received geolocated event data, and/or identifying a location based on analysis of the highest density of that event data over a period of time such as, e.g., but not limited to, 30, 60 or 90 days, according to an exemplary embodiment. In 108, according to an exemplary embodiment, the highest density, non-overlapping superblock may be identified, and/or a weighted average of the density for the superblock may be calculated and/or weighted, and/or may be assigned a cluster identifier (ID), according to an exemplary embodiment. From 108, flow diagram 100 may proceed with 110.

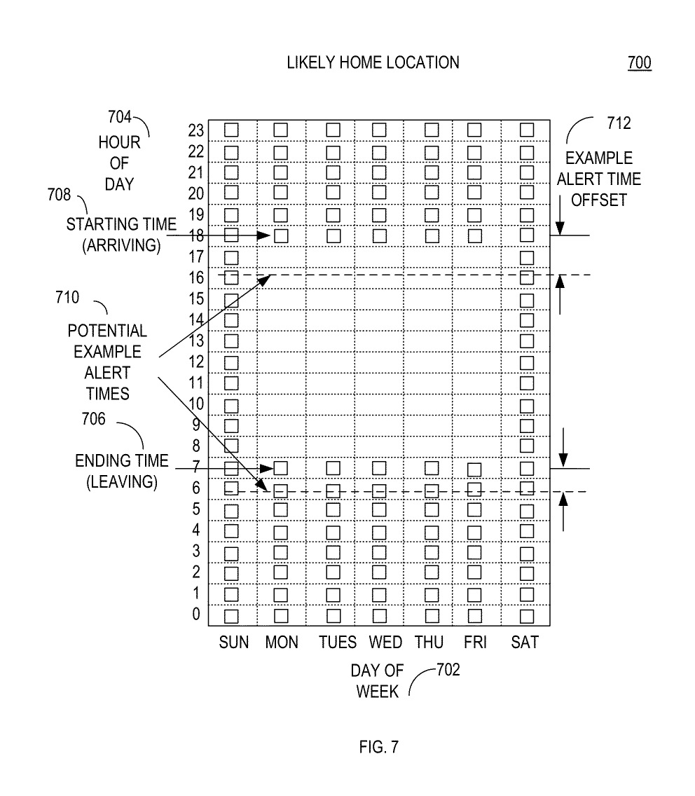

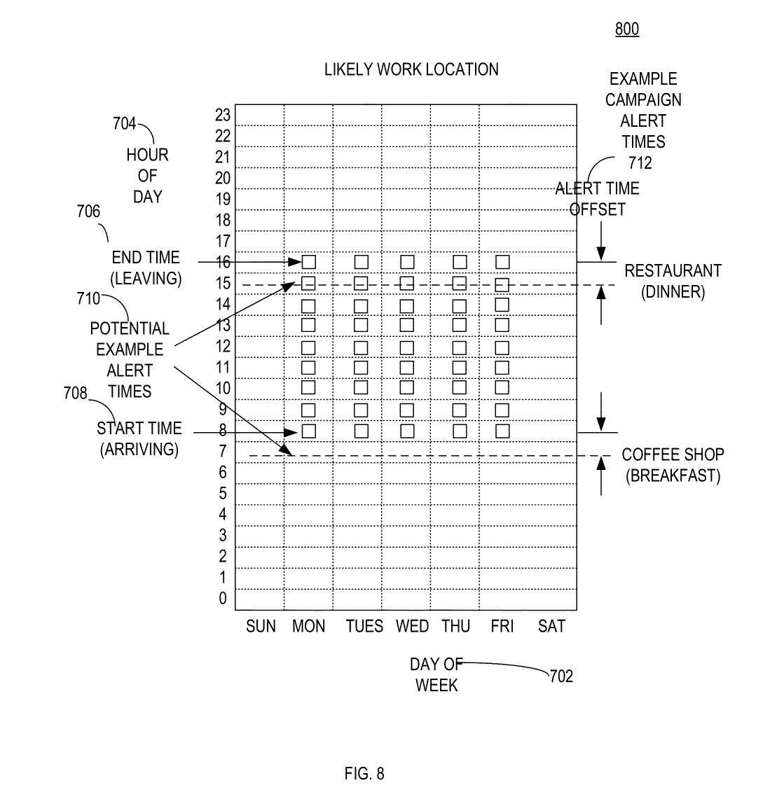

In 110, flow diagram 100 may determine, track and/or aggregate time periods (for each subscriber), when the subscriber is in the cluster, according to an exemplary embodiment. For example, as discussed further below with reference to FIGS. 7 and 8, according to one exemplary embodiment, event data for each cluster associated with a given subscriber, may be analyzed by, e.g., but not limited to, placing an aggregate amount of event data, such as, e.g., but not limited to, 30, 60 or 90 days of event data, into separate time period buckets, such as, e.g., but not limited to, buckets for each hour (of a 24 hour day) of each day of the week (of a 7 day week), etc., or some other increment of time, according to an exemplary embodiment. From 110, flow diagram 100 may proceed with 112.

In 112, flow diagram 100 may further optionally include (for each subscriber) analyzing the event data further, including, e.g., but not limited to, identifying exemplary types of clusters, and/or adding tags for each subscriber, based on, e.g., but not limited to, analysis, or by receiving tags, of any frequented location/cluster types including, e.g., but not limited to, an analyzed cluster types, provided cluster types, home, work, school, a long commute (e.g., but not limited to, around, or > or equal to 60 minutes in duration, etc.), a short commute (e.g., but not limited to, around, or < or equal to 15 minutes in duration, etc.), swing shift, alternate shift work, a nonstandard work hours, a vacation home, a museum, a restaurant, a place of interest (POI), a shopping destination, an entertainment venue, etc., according to an exemplary embodiment. Advantageously, the system may analyze the event data, and may identify exemplary indications of a cluster type, as may be derived from the time period data from 110, according to one exemplary embodiment. From 112, flow diagram 100 may proceed with 114.

In 114, flow diagram 100 may determine and/or provide and/or output predictive data or a prediction (for each subscriber), and such predictive data may include, e.g., but may not be limited to, location (Latitude, Longitude, Accuracy, etc.) and/or receiving and/or providing the prediction(s) and/or other data (such as, e.g., but not limited to, a radius, or range, time range (such as, e.g., but not limited to, time range at or in the vicinity/near a frequented location (e.g., but not limited to, within 10 miles, 1 mile, 1 km, etc.) and/or cluster, entry time, leave time, start time, stop time, entering, leaving, remaining in, start/stop, alert time, departing, arriving, and/or alert time relative to another time period (e.g., entry, leaving, staying, etc.) and/or demographics, psychographics, any tag or tags, and may make use of alert times, which may be relative to one of the time ranges, such as, within 30, 20, or 10 minutes of an expected departure time, based on, e.g., but not limited to, the analysis of the historical geolocated event data and the time range analysis, etc., according to an exemplary embodiment. From 114, flow diagram 100 may proceed with 116.

In 116, flow diagram 100 may include optionally using the predictive data and/or other data to support applications such as, e.g., but not limited to, a marketing campaign, a political campaign, a traffic management application, etc., according to an exemplary embodiment. In an exemplary embodiment, an exemplary application may include producing a marketing campaign, according to an exemplary embodiment. According to an exemplary embodiment, a campaign may include, e.g., but not limited to, a communication, an offer, an alert, a notification, an advertisement, a promotion, a marketing material, and/or a coupon, etc. According to an exemplary embodiment, the offering may be pushed to, e.g., but not limited to, a list of subscribers such as, e.g., but not limited to, a list of subscribers meeting a targeted audience, as well as expected to be near or within a threshold distance from a targeted location, at a future time based on the predictive data, which is based on analysis of historical event data, and/or other data, etc. Advantageously, a network service provider (NSP) and/or a communications service provider (CSP) may use its own geolocated event data, and may contact its customers by pushing an advertisement, etc. to the customer without revealing the service provider's customers' information, according to an exemplary embodiment. From 116, flow diagram 100 may proceed with 118.

In 118, flow diagram 100 may immediately end, according to an exemplary embodiment.

FIG. 2 illustrates an exemplary diagram 200 illustrating various exemplary location based historical data sources, including, e.g., but not limited to, GPS data 218, per call measurement data (PCMD) 214, and/or call detail record (CDR) data 216, and/or exemplary processing according to an exemplary embodiment of the present invention. As shown, according to an exemplary embodiment, a mobile user, such as, e.g., but not limited to, subscriber A 201 may have an exemplary mobile device 202, which according to an exemplary embodiment may be an exemplary smartphone, and may, according to an exemplary embodiment, may in turn be communicating with, e.g., but not limited to, one or more cellular communications towers 204a, 204b, coupled to an exemplary base station controller (BSC) 206, which may be coupled via an exemplary packet data serving node (PDSN) 211 to a data network 212, and/or the BSC 206 may be coupled to the PSTN 210 via an exemplary MSC 208, according to an exemplary embodiment, and from the BSC 206, location data may be captured via processing of per call measurement data (PCMD) 214; and/or GPS satellites 217, and/or an exemplary global positioning system (GPS) feature of the mobile device 202, which may receive exemplary GPS data 218 location information from exemplary GPS satellites 217; and/or the calls of mobile device 202 may be tracked in a call detail record (CDR) data record 216, which may be captured, according to an exemplary embodiment, from a switch or a mobile switching center (MSC) 208, which may be coupled to the base station controller (BSC) 206, and/or the public switched telephone network (PSTN) 210, and/or a data network 212 for voice over Internet Protocol (VoIP) type data. The GPS location data 218 may include a latitude, a longitude, and an accuracy, e.g., the GPS location data 218, according to an exemplary embodiment may be accurate to a level, of approximately 5 m, according to an exemplary embodiment, etc. As shown, raw PCMD data 214 may be captured and/or may be time stamped, along with capture of a location, which may be used to determine exemplary location information, which may include a latitude, a longitude, and an accuracy, such as, e.g., but not limited to, an accuracy of approximately less than approximately 100-300 m, according to an exemplary embodiment. As further shown, the CDR data 216, according to an exemplary embodiment, may be used including, e.g., but not limited to, an exemplary switch ID and/or cell ID, which may then be further processed and/or analyzed to ascertain an approximate location of the subscriber device 202 where the location may include a latitude and longitude, and an accuracy, wherein an exemplary accuracy may be, e.g., but not limited to, approximately less than 1-10 m, according to an exemplary embodiment. The geolocated event data, which may be collected according to an exemplary embodiment, from GPS data 218, PCMD data 214, and/or CDR data 216, etc., may be aggregated and/or collected and/or gathered, and/or may be provided, and/or may be further processed as discussed above with reference to 104 of FIG. 1, according to an exemplary embodiment. The geolocated event data may be provided, and may include, according to an exemplary embodiment, an exemplary location (i.e., Latitude and Longitude), and/or Accuracy, and then may be processed further in an exemplary embodiment. As shown and discussed in FIG. 1, this type of geolocated event data may then be received 106, and may be analyzed to identify frequented locations or clusters 108, time frames of the geolocated event data may then be analyzed and placed into exemplary time period buckets in 110, which may include day of week, and hour of day, or other portion of day buckets (morning, night, etc.), in 112, optionally any tags for each subscriber may be identified, determined and/or tagged, and then based on this aggregated and analyzed geolocated event based data may be used to predict in 114 when the subscriber will enter, leave or stay in future location (e.g., latitude, longitude, and/or radius and/or area, and/or accuracy), at a future date and time, and then, in 116 optionally, this predictive information may be provided as output, and/or may be used to assist in creating an exemplary application, such as, e.g., but not limited to, a campaign, such as, e.g., but not limited to, a marketing campaign, a political campaign, a traffic management application, another application, a targeted campaign, etc., according to an exemplary embodiment.

FIG. 3 illustrates an exemplary flow chart 108 depicting an exemplary process of identifying frequently visited locations by a given subscriber, according to an exemplary embodiment of the present invention.

Flow diagram 108 may begin with 302, and may continue immediately with 304, according to an exemplary embodiment.

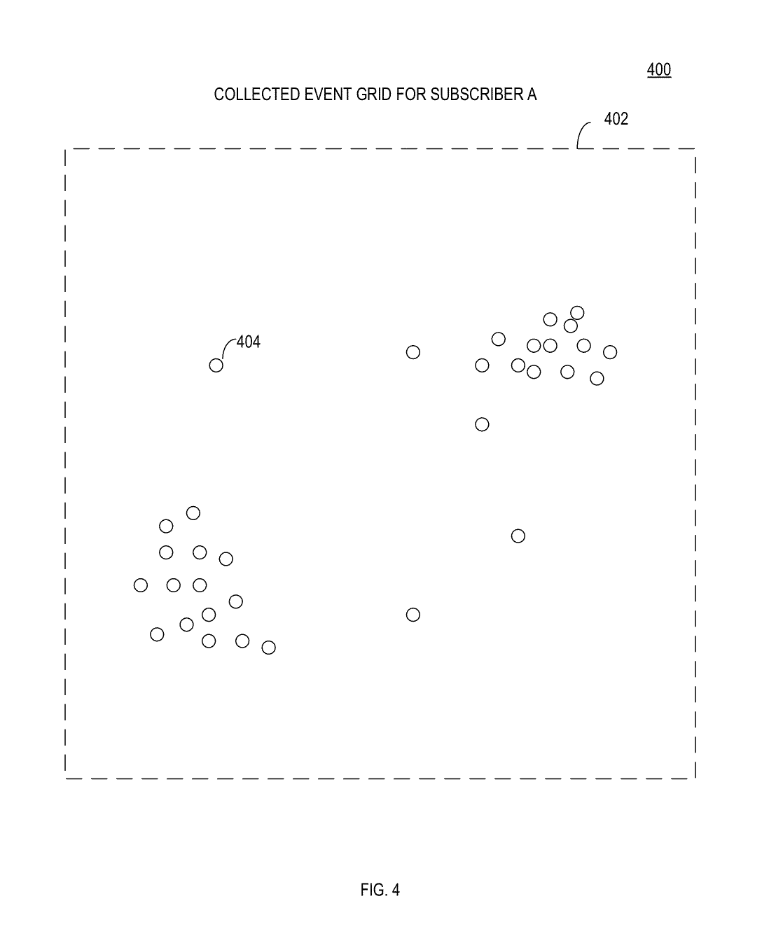

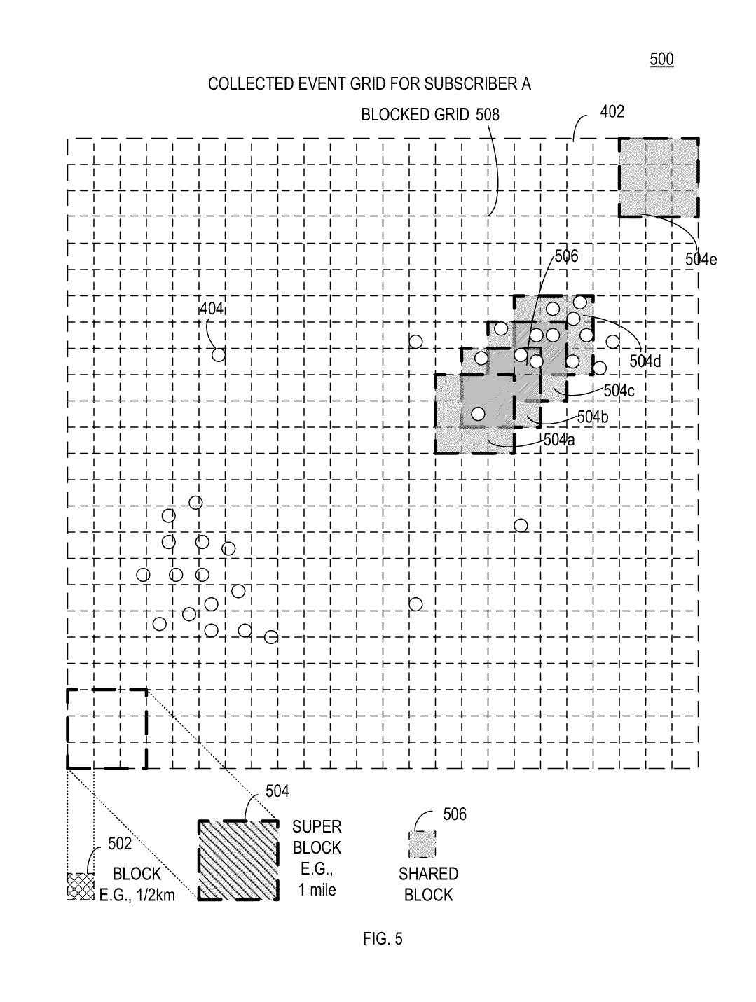

In 304, flow diagram 108 may receive, or choose a block size, or may receive a selection of an appropriately sized block to provide sufficient granularity of location, according to an exemplary embodiment. In certain geographies, e.g., in an urban downtown, a map may need to be of a much smaller granularity block size, than in the case of analyzing event data in a rural area, according to an exemplary embodiment. The block size is selected to be of sufficiently small granularity to effectively identify distinct areas of the geolocated event data, according to an exemplary embodiment. An example block 502 is shown and described further with reference to FIG. 5 below, for an exemplary collected event grid for an exemplary subscriber A map of exemplary geolocated events 404 shown in grid 402 of FIG. 4 including blocked grid 508. From 304, flow diagram 308 may proceed with 306.

In 306, flow diagram 108 may receive a choice of a size of superblock 504 (introduced and discussed further below with reference to FIG. 5) that may be a multiple of the block size, such as, e.g., but not limited to, an exemplary nine (9) times the size of the block 502, etc., according to an exemplary embodiment. From 306, flow diagram 108 may proceed with 308.

In 308, flow diagram 108 may create an exemplary blocked grid 508 over grid 402 discussed further with reference to FIGS. 4 and 5 whose cell size is the block 502 size, where the exemplary event grid 402 may cover an exemplary entire exemplary geographic area of the exemplary geolocated events being analyzed, such as, e.g., but not limited to, a map of the world, a country (e.g., USA), a state (e.g., Virginia), an exemplary region, exemplary county, city, town, village, neighborhood, and/or other geographic area, etc., according to an exemplary embodiment. From 308, flow diagram 108 may proceed with 310.

In 310, flow diagram 108 may determine a number of geolocated events in each and every superblock 504 (discussed further below with reference to FIG. 5) of the collected event grid 402, for each of the superblocks 504 of the blocked grid 508, according to an exemplary embodiment. From 310, flow diagram 108 may proceed with 312.

In 312, flow diagram 108 may first create a list of exemplary superblocks 504 (as discussed further with reference to FIG. 5), with the number of the events that are contained in the given superblock 504. From 312, flow diagram 108 may continue with 314, according to exemplary embodiment.

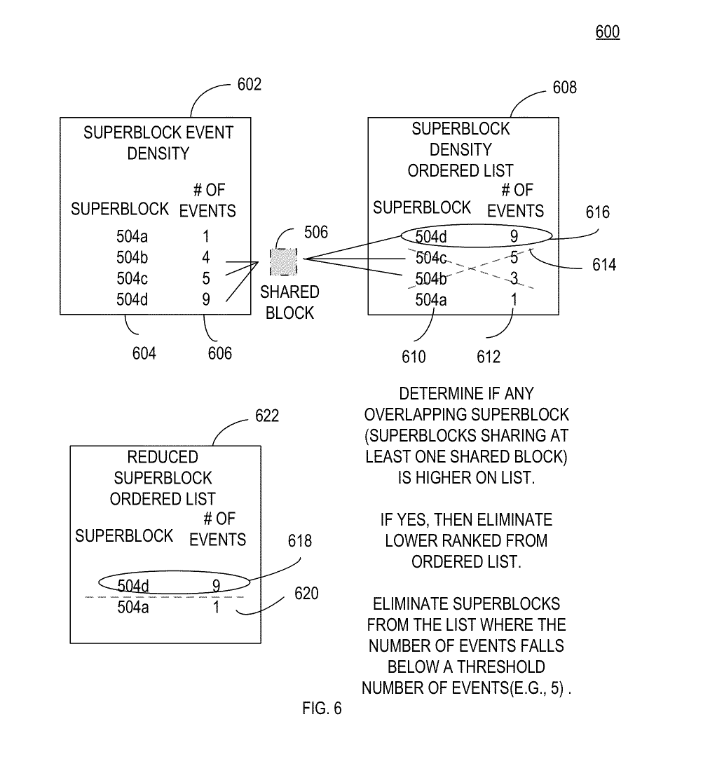

In 314, the list 608 (discussed further below with reference to FIG. 6) of superblocks 504 discussed in FIGS. 5 and 6, may be ordered by the number of events 610 in the given superblock, in descending order, as illustrated further below with reference to FIG. 6 and list 602 and ordered list 608, according to an exemplary embodiment. From 314, flow diagram 108 may proceed with 316.

In 316, flow diagram 108 may include eliminating any superblock 504 or superblocks from the ordered list 610, that may share a block 506 with another superblock 504 that is higher on the ranked ordered list 608, as illustrated and discussed further with reference to FIG. 6, at reference 608, according to an exemplary embodiment. From 316, flow diagram 108 may proceed with 318.

In 318, flow diagram 108 may include eliminating exemplary superblocks 504, which may have a number of events that fall below an exemplary threshold value of number of events as illustrated in exemplary table 622 of FIG. 6 (e.g., less than a finite absolute number of events, such as, e.g. but not limited to, less than 5, less than 10, less than 20, etc., according to an exemplary embodiment). From 318, flow diagram 108 may proceed with 320.

In 320, flow diagram 108 may immediately end, according to an exemplary embodiment.

FIG. 4 illustrates an exemplary diagram 400 illustrating an exemplary collected event grid 402 showing a plurality of collected exemplary geolocated event data (GED) point(s) 404 for a given subscriber A 201, as may have been accumulated over an exemplary time period of e.g., but not limited to, 30, 60, and/or 90 days, or less, or more etc., according to an exemplary embodiment of the present invention. As shown, the entire area of the events may span the grid 402. In an exemplary embodiment, for the subscriber 201, events appear to be scattered across the geography represented by the grid, but appear to have several areas or clusters of events of higher concentration. According to an exemplary embodiment, the claimed invention may identify the clusters of these events.

FIG. 5 illustrates an exemplary diagram 500 showing an exemplary blocked grid 508 of exemplary collected event grid 402 for the exemplary subscriber A 201 illustrating an exemplary block 502 and an exemplary superblock 504 definition (according to an exemplary embodiment, superblock 504 may be a multiple of block 502), and illustrating various exemplary superblocks 504a, 504b, 504c, and 504d, according to an exemplary embodiment of the present invention. Various exemplary events 404 are plotted on the grid 402. Exemplary block 502 is shown to represent an exemplary, but nonlimiting geographic area of an exemplary approximately ½ km, however any other size block could also be used, and as noted may be selectable, or selected based on the type and/or characteristics of the particular geographic area. Further exemplary superblocks 504 having an exemplary but nonlimiting size of approximately nine (9) times the area of a block, in this example an exemplary area of approximately 1 mile, but any other sized superblock could be used. As illustrated, one may note that superblocks 504b, 504c, and 504d share a common block 506, and thus these superblocks 504b-d may be said to be overlapping blocks in that their areas share at least one block 506. Any combination of superblocks 504b-d may have various shared 506 blocks 502. Each and every superblock may be counted and listed as noted with reference to FIG. 3.

FIG. 6 illustrates an exemplary diagram 600 of various exemplary tables 602, 608, and 622 including illustrating an exemplary process of identifying frequented locations of a given subscriber, an exemplary cluster, which may include creating a list 602 of a group 604 of superblocks 504a-504d along with occurrences 606 of the geolocated events for each of the superblocks 504. Then the list 602 may be ordered in an ordered list 608 ordering superblocks 504 by an exemplary event frequency 612, and eliminating as illustrated with crossed out (X) 614 of lower ranked superblocks 504c, 504b that overlap a higher ranked superblock 504d labeled with ellipse 616, according to an exemplary embodiment of the present invention. According to an exemplary embodiment, for superblocks 504a-504d of FIG. 5, in FIG. 6 the frequency of GEDs for exemplary superblocks 504a-504d are listed in table 602 with for each superblock identifier (ID) 604, there is a corresponding number of GED events 606, according to an exemplary embodiment. The list 604 of superblocks 504 with associated frequency of events density 606, is then ordered as shown in 608 by the number of events within the superblock by sorting the records based on the value of column 612 from highest to lowest number of GEDs, descending, according to an exemplary embodiment. As illustrated in FIGS. 5 and 6, for the three (3) superblocks 504b-504d, having a shared block 506, the lower ranked overlapping superblocks 504c, 504b, of the higher ranking superblock 504d, may be eliminated as illustrated with cross-through 614 (as illustrated by the crossing out of 504b and 504c). As noted, the process may determine if any overlapping superblocks (superblocks sharing at least one shared block) is higher on the list. If so, then the lower ranked superblock(s) 614 may be removed from the list, according to an exemplary embodiment. Once the highest ranked superblocks 616 are identified, the frequented superblocks 616 may be thought of frequented location(s), or clusters, and the location of the superblock 504 may be a weighted average of the locations of the GEDs in that superblock, according to an exemplary embodiment. According to an exemplary embodiment, to determine a cluster, according to one exemplary embodiment, the process may use an exemplary threshold density of (e.g., 5, 10, etc.) to determine whether a superblock is a cluster, e.g., a threshold may be set to consider at least 9 GEDs out of a 90 day aggregated GED data sample. With a threshold cutoff of at least 9, then cluster 620 would be eliminated from table 622, and only frequented location 618 would remain for superblock 504, according to an exemplary embodiment.

FIG. 7 illustrates an exemplary diagram 700 depicting an exemplary day of week 702, by exemplary hour of day 704 grid, which may be used to identify exemplary time periods or exemplary buckets for a first given exemplary frequented location of a given subscriber, which may be used to identify exemplary starting time 708 and stopping and/or ending time 706, and illustrating exemplary potentially useful alert times 710 relative to the exemplary starting time, according to an exemplary embodiment. As illustrated, the table 700 may be populated with the time periods for each day of the week 702, and hour of the day 704 for all the exemplary aggregated GEDs for the given subscriber (other time period buckets may also be used. In an exemplary embodiment, separate buckets provided may include a bucket for each day of the week 702, as well as organizing the GEDs, by the hour of the day 704 within which the subscriber was in the GED location of interest. For cluster 700, it may be seen that the subscriber is at this location most weekends, evenings, and early mornings. An exemplary ending/leaving time 706 may be identified as the last time that the user was at the location for a given period of time. An exemplary starting time 708 may represent the beginning of another period of time that the subscriber may be expected to return to the given location of the cluster. The system may predict that the subscriber is probabilistically likely to be entering or leaving the location of the cluster at the specific ending 706 and starting times 708, and various alert times 710 may be identified, which may be offset at an exemplary time period of offset 712 slightly before (e.g., but not limited to an alert time offset of 10 minutes prior to the time period of the starting time 708 or ending time 706. Since this particular example appears to have the subscriber in this location on weekends, early morning and evenings, it may be predicted that this frequented location (cluster) is associated with the exemplary subscriber's home. Other alternative work schedules might be less uniform (e.g., a shift worker, or a revolving/swing shift worker, etc.).

FIG. 8 illustrates another exemplary day of week 702 by hour of day 704 grid, which may be used to identify exemplary time periods for a second given exemplary frequented location for the given subscriber 201, which may be used to identify exemplary starting times 708 and stopping or ending times 706, and illustrating exemplary alert times 710 offset 712 relative to the exemplary starting time 708, ending time 706, and/or other time periods, etc., according to an exemplary embodiment. As shown in the example, for this particular frequented location (cluster), the frequented location may be predicted to be a work location since the subscriber is at the location generally during the work week approximately 9 am-5 pm Mondays through Fridays.

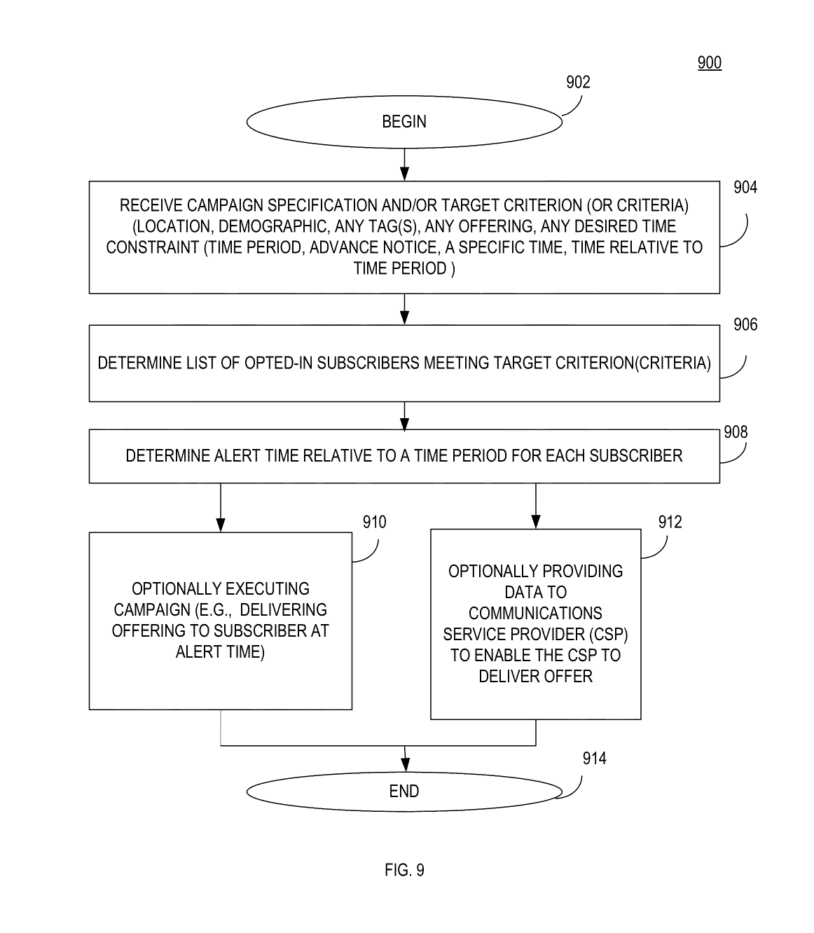

FIG. 9 illustrates an exemplary flow chart 900 depicting an exemplary process of using the exemplary frequented location and exemplary time period information generated out of the geolocated location based events data and exemplary expected time periods, to conduct an exemplary application, in this case, an exemplary targeted campaign, according to an exemplary embodiment of the present invention.

Flow diagram 900 may begin with 902, and may continue immediately with 904, according to an exemplary embodiment.

In 904, flow diagram 900 may receive an exemplary campaign specification and/or optionally target criterion/criteria such as, e.g., but not limited to, location, demographics of target, any tags, and/or any desired time range or time period to target, or other time constraint such as, e.g., but not limited to, a time period, an advance notice, a specific time, a time relative to a time period, etc.), according to an exemplary embodiment. From 904, flow diagram 900 may proceed with 906.

In 906, flow diagram 900 may determine a list of subscribers meeting the targeted criterion (criteria) of the exemplary marketer, according to an exemplary embodiment. From 906, flow diagram 900 may proceed with 908.

In 908, flow diagram 900 may receive or determine an alert time relative to an exemplary time period for an exemplary subscriber. For example, depending on the exemplary offer from a marketer or other entity seeking to reach or promote the targeted subscriber users, an alert time may be selected, to achieve a desired advance offset of the subscribers expected arrival and/or departure time, according to an exemplary embodiment. For example, flow diagram 900 may determine an alert time or times for each subscriber, including an exemplary offset from the associated start/stop time, according to an exemplary embodiment. From 908, flow diagram 900 may proceed with 910 or 912, according to various alternative embodiments.

In 910, optionally, a campaign may be executed including, e.g., but not limited to, delivering an offering or communication to a subscriber at a requested offset time from an exemplary desired alert time, according to an exemplary embodiment. From 910, flow diagram 900 may proceed with 912. From 910, flow diagram 900 may proceed with 914 and may immediately end.

In 912, flow diagram 900 may optionally provide data to a communications service provider (CSP) to enable the CSP to deliver the offer to the subscriber at the alert time, according to an exemplary embodiment. From 912, flow diagram 900 may proceed with 914 and may immediately end.

According to one exemplary embodiment, privacy of the subscriber's personal data may be maintained, advantageously, according to an exemplary embodiment. According to an exemplary embodiment, a subscriber may optionally opt-in, or opt-out, depending on a default for obtaining user waiver and/or the subscriber may agree to receive marketing material from entities wishing to solicit business from the exemplary subscriber, according to an exemplary embodiment.

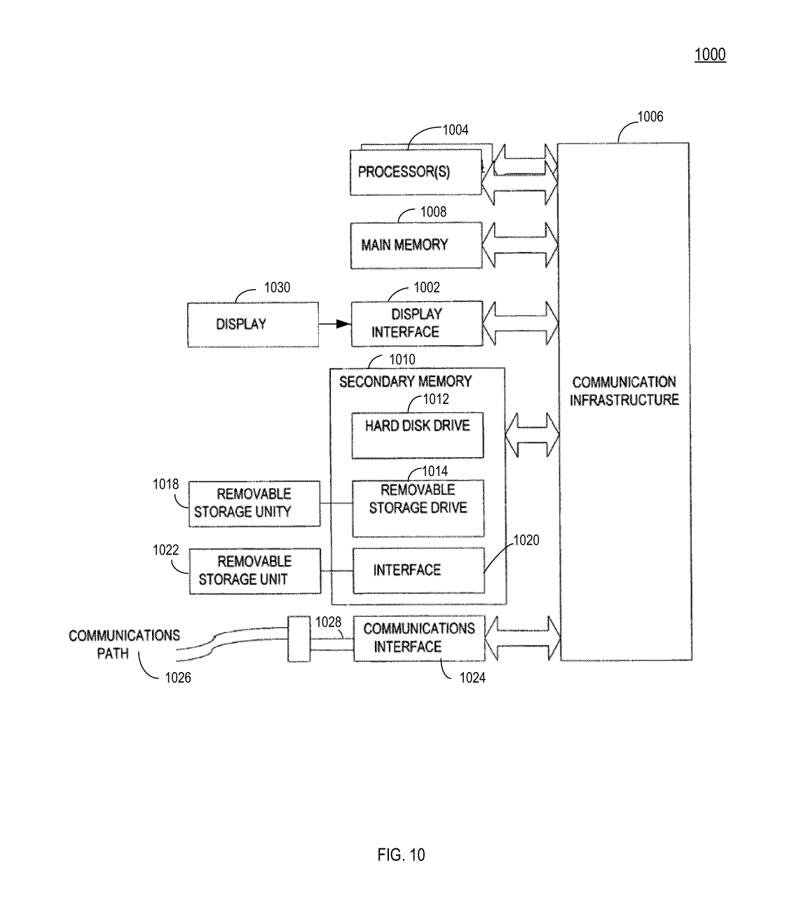

FIG. 10 illustrates an exemplary computer system as may be used in implementing an exemplary component of the system, according to an exemplary embodiment of the invention. FIG. 10 depicts an exemplary diagram 1000 illustrating an exemplary computer/communications device hardware architecture as may be used in various components of exemplary embodiments of the present invention. FIG. 10 depicts an exemplary diagram 1000 illustrating an exemplary computer/communications device hardware architecture as may be used in various components of exemplary embodiments of the present invention. FIG. 10 depicts an exemplary view 1000 of an exemplary computer system 202, 206, 208, 211, 214, 216, 218, etc. as may be used in implementing an exemplary embodiment of the present invention. FIG. 10 depicts an exemplary embodiment of a computer system that may be used in computing devices such as, e.g., but not limited to, user devices 202, communications service provider devices 206, 208, 211, 214, 216, 218, etc. and/or web server (not shown) and/or application server (not shown), network computing device(s) of Data network 212 and/or PSTN network 210, network components 1026, etc. according to an exemplary embodiment of the present invention. FIG. 10 depicts an exemplary embodiment of a computer system that may be used as client device 202, or a server device (not shown), etc. The present invention (or any part(s) or function(s) thereof) may be implemented using hardware, software, firmware, or a combination thereof and may be implemented in one or more computer systems or other processing systems. In fact, in one exemplary embodiment, the invention may be directed toward one or more computer systems capable of carrying out the functionality described herein. An example of a computer system 1000 is shown in FIG. 10, depicting an exemplary embodiment of a block diagram of an exemplary computer system useful for implementing the present invention. Specifically, FIG. 10 illustrates an example computer 1000, which in an exemplary embodiment may be, e.g., (but not limited to) a personal computer (PC) system running an operating system such as, e.g., (but not limited to) WINDOWS MOBILE™ for POCKET PC, or MICROSOFT® WINDOWS® NT/98/2000/XP/CE/7/8/n, etc. available from MICROSOFT® Corporation of Redmond, Wash., U.S.A., SOLARIS® from SUN® Microsystems of Santa Clara, Calif., U.S.A, OS/2 from IBM® Corporation of Armonk, N.Y., U.S.A, Mac/OS, OS/X, iOS from APPLE® Corporation of Cupertino, Calif., U.S.A, etc, or any of various versions of UNIX® (a trademark of the Open Group of San Francisco, Calif., USA) including, e.g., LINUX®, HPUX®, IBM AIX®, and SCO/UNIX®, etc. However, the invention may not be limited to these platforms. Instead, the invention may be implemented on any appropriate computer system running any appropriate operating system. In one exemplary embodiment, the present invention may be implemented on a computer system operating as discussed herein. An exemplary computer system, computer 1000 is shown in FIG. 10. Other components of the invention, such as, e.g., (but not limited to) a computing device, a communications device, a telephone, a personal digital assistant (PDA), a personal computer (PC), a handheld PC, client workstations, thin clients, thick clients, proxy servers, network communication servers, remote access devices, client computers, server computers, routers, web servers, data, media, audio, video, telephony or streaming technology servers, a tablet, a phone, a mobile phone, a cellular phone, a communications device, an iPod, an iPhone, a smartphone, an iPad, a tablet based device, a smart phone, an ANDROID OS device, an iOS device, a Symbian based device, a Windows 8 device, etc., may also be implemented using a computer such as that shown in FIG. 10.

The computer system 1000 may include one or more processors, such as, e.g., but not limited to, processor(s) 1004. The processor(s) 1004 may be connected to a communication infrastructure 1006 (e.g., but not limited to, a communications bus, cross-over bar, or network, etc.). Various exemplary software embodiments may be described in terms of this exemplary computer system. After reading this description, it will become apparent to a person skilled in the relevant art(s) how to implement the invention using other computer systems and/or architectures.

Computer system 1000 may include a display interface 1002 that may forward, e.g., but not limited to, graphics, text, and other data, etc., from the communication infrastructure 1006 (or from a frame buffer, etc., not shown) for display on the display unit 1030.

The computer system 1000 may also include, e.g., but may not be limited to, a main memory 1008, random access memory (RAM), and a secondary memory 1010, etc. The secondary memory 1010 may include, for example, (but not limited to) a hard disk drive (storage device) 1012 and/or a removable storage drive 1014, representing a floppy diskette drive, a magnetic tape drive, an optical disk drive, a compact disk drive CD-ROM, solid state memory, flash memory, SD card, etc. The removable storage drive 1014 may, e.g., but not limited to, read from and/or write to a removable storage unit 1018 in a well known manner. Removable storage unit 1018, also called a program storage device or a computer program product, may represent, e.g., but not limited to, a floppy disk, magnetic tape, optical disk, compact disk, etc. which may be read from and written to by removable storage drive 1014. As will be appreciated, the removable storage unit 1018 may include a computer usable storage medium having stored therein computer software and/or data.

In alternative exemplary embodiments, secondary memory 1010 may include other similar devices for allowing computer programs or other instructions to be loaded into computer system 1000. Such devices may include, for example, a removable storage unit 1022 and an interface 1020. Examples of such may include a program cartridge and cartridge interface (such as, e.g., but not limited to, those found in video game devices), a removable memory chip (such as, e.g., but not limited to, an erasable programmable read only memory (EPROM), or programmable read only memory (PROM) and associated socket, and other removable storage units 1022 and interfaces 1020, which may allow software and data to be transferred from the removable storage unit 1022 to computer system 1000.

Computer 1000 may also include an input device such as, e.g., (but not limited to) a mouse or other pointing device such as a digitizer, and a keyboard or other data entry device (none of which are labeled).

Computer 1000 may also include output devices, such as, e.g., (but not limited to) display 530, and display interface 1002. Computer 1000 may include input/output (I/O) devices such as, e.g., (but not limited to) communications interface 1024, cable 1028 and communications path 1026, etc. These devices may include, e.g., but not limited to, a network interface card, and modems (neither are labeled). Communications interface 1024 may allow software and data to be transferred between computer system 1000 and external devices. Examples of communications interface 1024 may include, e.g., but may not be limited to, a modem, a network interface (such as, e.g., an Ethernet card), a communications port, a Personal Computer Memory Card International Association (PCMCIA) slot, PC Card, SDRAM, universal serial bus (USB), solid state device (SSD), and card, etc. Software and data transferred via communications interface 1024 may be in the form of signals 1028 which may be electronic, electromagnetic, optical or other signals capable of being received by communications interface 1024. These signals 1028 may be provided to communications interface 1024 via, e.g., but not limited to, a communications path 1026 (e.g., but not limited to, a channel). This channel 1026 may carry signals 1028, which may include, e.g., but not limited to, propagated signals, and may be implemented using, e.g., but not limited to, wire or cable, fiber optics, a telephone line, a cellular link, an radio frequency (RF) link and other communications channels, etc. When non transitory, the program product may encapsulate such data.

In this document, the terms “computer program medium” and “computer readable medium” may be used to generally refer to media such as, e.g., but not limited to removable storage drive 1014, a hard disk installed in hard disk drive 1012, and signals 1028, etc. These computer program products may provide software to computer system 1000. The invention may be directed to such computer program products.

References to “one embodiment,” “an embodiment,” “example embodiment,” “various embodiments,” etc., may indicate that the embodiment(s) of the invention so described may include a particular feature, structure, or characteristic, but not every embodiment necessarily includes the particular feature, structure, or characteristic. Further, repeated use of the phrase “in one embodiment,” or “in an exemplary embodiment,” do not necessarily refer to the same embodiment, although they may.

In the following description and claims, the terms “coupled” and “connected,” along with their derivatives, may be used. It should be understood that these terms are not intended as synonyms for each other. Rather, in particular embodiments, “connected” may be used to indicate that two or more elements are in direct or indirect physical or electrical contact with each other. “Coupled” may mean that two or more elements are in direct physical or electrical contact. However, “coupled” may also mean that two or more elements are not in direct contact with each other, but yet still co-operate or interact with each other.

An algorithm is here, and generally, considered to be a self-consistent sequence of acts or operations leading to a desired result. These include physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers or the like. It should be understood, however, that all of these and similar terms are to be associated with the appropriate physical quantities and are merely convenient labels applied to these quantities.

Unless specifically stated otherwise, as apparent from the following discussions, it is appreciated that throughout the specification discussions utilizing terms such as “processing,” “computing,” “calculating,” “determining,” or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices.

In a similar manner, the term “processor” may refer to any device or portion of a device that processes electronic data from registers and/or memory to transform that electronic data into other electronic data that may be stored in registers and/or memory. A “computing platform” may comprise one or more processors.

Embodiments of the present invention may include apparatuses for performing the operations herein. An apparatus may be specially constructed for the desired purposes, or it may comprise a general purpose device selectively activated or reconfigured by a program stored in the device.

Embodiments of the invention may be implemented in one or a combination of hardware, firmware, and software. Embodiments of the invention may also be implemented as instructions stored on a machine-readable medium, which may be read and executed by a computing platform to perform the operations described herein. A machine-readable medium may include any mechanism for storing or transmitting information in a form readable by a machine (e.g., a computer). For example, a machine-readable medium may include read only memory (ROM); random access memory (RAM); magnetic disk storage media; optical storage media; flash memory devices; electrical, optical, acoustical or other form of propagated signals (e.g., carrier waves, infrared signals, digital signals, etc.), and others.

Computer programs (also called computer control logic), may include object oriented computer programs, and may be stored in main memory 1008 and/or the secondary memory 1010 and/or removable storage units 1014, also called computer program products. Such computer programs, when executed, may enable the computer system 1000 to perform the features of the present invention as discussed herein. In particular, the computer programs, when executed, may enable the processor 1004 to provide various functionality to the system so as to identify frequented locations from geolocated event data, according to an exemplary embodiment of the present invention. Accordingly, such computer programs may represent controllers of the computer system 1000.

In another exemplary embodiment, the invention may be directed to a computer program product comprising a computer readable medium having control logic (computer software) stored therein. The control logic, when executed by the processor 1004, may cause the processor 1004 to perform the functions of the invention as described herein. In another exemplary embodiment where the invention may be implemented using software, the software may be stored in a computer program product and loaded into computer system 1000 using, e.g., but not limited to, removable storage drive 1014, hard drive 1012 or communications interface 1024, etc. The control logic (software), when executed by the processor 1004, may cause the processor 1004 to perform the functions of the invention as described herein. The computer software may run as a standalone software application program running atop an operating system, or may be integrated into the operating system.

In yet another embodiment, the invention may be implemented primarily in hardware using, for example, but not limited to, hardware components such as application specific integrated circuits (ASICs), or one or more state machines, etc. Implementation of the hardware state machine so as to perform the functions described herein will be apparent to persons skilled in the relevant art(s).

In another exemplary embodiment, the invention may be implemented primarily in firmware.

In yet another exemplary embodiment, the invention may be implemented using a combination of any of, e.g., but not limited to, hardware, firmware, and software, etc.

Exemplary embodiments of the invention may also be implemented as instructions stored on a machine-readable medium, which may be read and executed by a computing platform to perform the operations described herein. A machine-readable medium may include any mechanism for storing or transmitting information in a form readable by a machine (e.g., a computer). For example, a machine readable medium may include read only memory (ROM); random access memory (RAM); magnetic disk storage media; optical storage media; flash memory devices; electrical, optical, acoustical or other form of propagated signals (e.g., carrier waves, infrared signals, digital signals, etc.), and others.

The exemplary embodiment of the present invention makes reference to wired, or wireless networks. Wired networks include any of a wide variety of well known means for coupling voice and data communications devices together. A brief discussion of various exemplary wireless network technologies that may be used to implement the embodiments of the present invention now are discussed. The examples are non-limited. Exemplary wireless network types may include, e.g., but not limited to, code division multiple access (CDMA), spread spectrum wireless, orthogonal frequency division multiplexing (OFDM), 1G, 2G, 3G wireless, Bluetooth, Infrared Data Association (IrDA), shared wireless access protocol (SWAP), “wireless fidelity” (Wi-Fi), WIMAX, and other IEEE standard 802.11 compliant wireless local area network (LAN), 802.16-compliant wide area network (WAN), and ultrawideband (UWB), etc.

Bluetooth is an emerging wireless technology promising to unify several wireless technologies for use in low power radio frequency (RF) networks.

IrDA is a standard method for devices to communicate using infrared light pulses, as promulgated by the Infrared Data Association from which the standard gets its name. Since IrDA devices use infrared light, they may depend on being in line of sight with each other.

The exemplary embodiments of the present invention may make reference to WLANs. Examples of a WLAN may include a shared wireless access protocol (SWAP) developed by Home radio frequency (HomeRF), and wireless fidelity (Wi-Fi), a derivative of IEEE 802.11, advocated by the wireless ethernet compatibility alliance (WECA). The IEEE 802.11 wireless LAN standard refers to various technologies that adhere to one or more of various wireless LAN standards. An IEEE 802.11 compliant wireless LAN may comply with any of one or more of the various IEEE 802.11 wireless LAN standards including, e.g., but not limited to, wireless LANs compliant with IEEE std. 802.11a, b, d or g, such as, e.g., but not limited to, IEEE std. 802.11a, b, d and g, (including, e.g., but not limited to IEEE 802.11g-2003, etc.), etc.

An exemplary computer system platform executing an exemplary software application program, which may reside, in an exemplary embodiment, on a user's client computing device 202, and/or on a server in interactive communication with the user's client computing device in a client/server, hierarchical, terminal server, or peer-to-peer fashion, may include, but is not limited to, a computing or communications device, smartphone, portable communications device, desktop/laptop computers, tablet computers, personal digital assistant, telephony, smartphone, mobile device, mobile phone, wireless device, tablet, personal digital assistant, handheld and the like, which may in an exemplary embodiment, be the device capable of providing user display or other output and receiving input from user interactive selections via any of various well known input devices, for receipt of offerings and/or other applications relating to location based predictive location data tied to targeted time periods. According to an exemplary embodiment, various versions of the exemplary software program, which may be an applet, a standalone application program, a browser based user interface, a Java applet, among various other embodiments as will be apparent to those skilled in the art, and as discussed further below, according to exemplary embodiments. In an exemplary embodiment, browser based interactive interfaces, or an application or applet, such as a toolbar, or browser based toolbar may be included. In another exemplary embodiment, the toolbar may be an applet, or other application program that may be provided in any of various well known ways, such as, e.g., but not limited to, an Internet browser-based toolbar, a JAVA applet, an ANDROID application, a Windows 7 or Windows 8, etc. application program, an iPOD, iPhone, or iPAD application, a MAC OS/X application, an iOS application, or the like, etc.

Various exemplary embodiments of a network-based system architecture high level diagram as shown in FIG. 2, according to an exemplary embodiment may be coupled together by an exemplary cloud-based architecture network, according to an exemplary embodiment.

According to an exemplary embodiment an exemplary cloud/network system and software, or a remote client server topology, a world wide web based (WWW) internet browser based application, or the like application may be provided. Users as shown in diagram 200 may access applications, in an exemplary embodiment via a network illustrated by the cloud, which may include, for example web servers such as, e.g., but not limited to, domain name servers (DNS) servers capable of domain name resolution, and hyper text markup language (HTML), JAVA applications, and/or extensible markup language (XML) implemented interactive applications, as a service offering may be implemented, and may allow, e.g., but not limited to, interactive client to remote server device interaction in well known matters via various wellknown network protocols such as the internet protocol (IP) and the transmission control protocol (TCP), as well as any well known network stack implementing the various communications layers of the OSI model for standard communication between two or more computing devices. According to an exemplary embodiment, many exemplary commercial cloud service providers may be used to host an application, if not a separate server one may use a cloud based offering such as, e.g., but not limited to, Amazon, Rackspace, Microsoft and/or many others as will be apparent to those skilled in the art, offering such capabilities, or alternatively application service providers (ASPs), software as a service (SAAS) providers, etc.

Various exemplary embodiments of an exemplary system may include an exemplary distributed network environment, according to an exemplary embodiment. An exemplary communications device, a personal computer (PC), tablet, or smartphone, among other devices by which a user may access a network to gain access to other network resources, according to an exemplary embodiment. According to an exemplary embodiment, the user device 202 may communicate via a network to other user devices 202 via any of various communications applications such as, e.g., but not limited to, electronic mail systems, or a social network including an exemplary social network service provider device also coupled to network, according to an exemplary embodiment. According to various embodiments, the user devices may also access an exemplary promotions service provider, which as illustrated may include a service provider user device as may be used to handle, e.g., specifications for a campaign, demographics, other targeting information, or for processing financial transactions to, e.g., but not limited to, a bank and/or credit card service, etc. As shown, the user devices 202 may access the exemplary service provider, via, e.g., but not limited to, a browser-based internet application, which may be accessed via an exemplary web server (not shown), which may perform such functions as providing load balancing and/or security, and/or a firewall for the service provider, as well as may then serve access to one or more application servers, such as, e.g., but not limited to, may include a database management system such as, e.g., but not limited to, a relational database, or other application software system, according to an exemplary embodiment. Further, as illustrated, other devices of users such as, e.g., but not limited to, marketer devices, or other vendor devices, may be used by a marketer user as illustrated in creating or entering campaign data for various goods and/or services as may be marketed using the system as disclosed, or understood by those skilled in the art, according to various embodiments of the invention. For example, a marketer device may be used to create an offer to be distributed to subscribers at a desired alert time, in proximity to a particular location, based on predictive data indicating a particular subscriber is expected to be in a location in the future (after the alert time, but potentially offset by a given time period from the desired expected time to arrive at the location), according to an exemplary embodiment.

An exemplary embodiment of the system may include an exemplary network environment. The high level system block diagram 200 of FIG. 2 may include, in an exemplary embodiment, users interacting with browsers on client devices 202a, or 202b (collectively 202), respectively. Browsers can be, e.g., but not limited to, application software programs executing on computer workstations or other computer processor based devices 202 (including mobile devices such as, e.g., but not limited to, communication devices, phones, smartphones, tablets, and/or computer tablets), which may be coupled via a network 212, 210 as shown (in wireline and/or wireless fashion) to other devices, as shown, in an exemplary embodiment. Workstations 202 can be coupled via a network 212, 210 such as, e.g., but not limited to, an internet, and intranet, or another type of network. In an exemplary embodiment network environment 104 may include the global Internet. Network 212 may provide access for client devices 202 to gain access to, e.g., but not limited to, one or more application servers (not shown), such as, e.g., but not limited to, a database management system (DBMS). Although a client server topology is discussed any of various other well-known types of communications topologies may also be used such as, e.g., but not limited to, point-to-point, peer-to-peer, cloud-based, software as a service (SAAS), browser-based, hierarchical, distributed, and/or centralized, etc. The application server can manage one or more databases. In an exemplary embodiment, the application server can access an exemplary database(s) having a plurality of data records, where in an exemplary embodiment, each data record may have one or more fields, etc. It will be apparent to those skilled in the art, that each database can be part of a larger database, or could be broken into a plurality of separate subdatabases. In an exemplary embodiment of the present invention, search results can include a plurality of records obtained from the database that meet search criteria included in a search query. Network 212 may be coupled to any of various well known components such as, e.g., but not limited to, one or more load balancing devices or firewall devices, web server(s), application server(s), routers, gateways, physical layer devices, data link layer devices, and/or network layer devices, etc.

Web servers and application servers may be coupled to one another via one or more network(s) 212. Although network 212, in an exemplary embodiment, may be downstream of load balancing devices, it is also possible to have a network upstream of load balancing devices, coupling, e.g., but not limited to, application server(s), web server(s), and/or database(s), as well as other client or other server devices (none are shown), local and/or remote from the depicted exemplary devices, etc. Exemplary client devices 202 are depicted downstream over an exemplary network(s) 212 from the server devices, but could easily be elsewhere in the network topology, e.g., inside, or outside a firewall. It is also important to note that network is represented in cloud metaphor schematic, but various well known network devices including various well-known star-based, bus-based, or other well known network topologies may also be represented by exemplary network(s).

A user interacting with a browser on workstation 202 can access the database, in an exemplary embodiment by traversing several intervening networks using well known communications protocols such as, e.g., but not limited to, transmission control protocol/internet protocol (TCP/IP). Specifically, in an exemplary embodiment, the workstation 202 can be coupled via exemplary network(s) 212 including, e.g., but not limited to, a public and/or private network, and/or the global Internet to any of various exemplary website system(s), in this exemplary case, web server(s), which may include any of various hosting systems such as, e.g., but not limited to, a domain system, a domain name server (DNS), a domain controller system, etc. Website or webserver system available from TEOCO Corporation of Fairfax, Va., according to one exemplary embodiment. The website system can include, in an exemplary embodiment, an exemplary firewall coupled to, or in addition to, or integrated with, a load balancer, which could alternatively run on a general purpose computer such as, e.g., web server, etc. Load balancers can be coupled to an exemplary web server. Web servers can be mesh coupled to one or more application servers, via hardware and/or software system solutions, according to an exemplary embodiment, or via another network. Each server, may include, e.g., but not limited to, or be coupled to, one or more database(s). Web server(s) in an exemplary embodiment, can perform load balancing functions by transferring user application requests/queries to one or more of the application servers. Results of the exemplary requests and/or queries from database can be transferred from application servers through web servers through the network to other workstations.

### Location Based Services (LBS)

Location Based Services (LBS) is expected to see explosive growth in 2013. Analysts are predicting that LBS will be a $4 B global business opportunity. In simple terms, LBS monetizes where mobile devices are. The business concept is to create a localized community whereby businesses can target the businesses' advertisements and thereby increase the revenues of the companies whose products are being advertised.

Various companies compete in LBS including FourSquare, Loopt and Shopkick, who are trying to establish communities utilizing global position system (GPS) location based data as a foundation.

### Predictive Analytics

Predictive analytics encompass a variety of statistical techniques from modeling, machine learning, and data mining that analyze current and historical facts to make predictions about future events. In business, predictive models exploit patterns found in historical and transactional data to identify risks and opportunities. Models capture relationships among many factors to allow assessment of risk or potential associated with a particular set of conditions, guiding decision making for candidate transactions.

Predictive analytics is used in actuarial science, marketing, financial services, insurance, telecommunications, retail, travel, healthcare, pharmaceuticals, and other fields. One well known example is credit scoring, which is used in financial services. Scoring models process a customer's credit history, loan application, customer data, etc., in order to rank-order individuals by their likelihood of making future credit payments on time. A well-known example would be the FICO score.

Behavior analysis also referred to as psychographic or behavioral demographics studies the behavior of users. Conventionally, behavior analysis tracks usage at an aggregated level, tracking numbers of users travelling to particular sites by analysis of log files, etc. Such information lacks details as to users, but rather tracks usage of a given site.

### Call Detail Records (CDRs)

A call detail record (CDR) is a data record produced by a telephone exchange, switch, or other telecommunications equipment documenting the details of a phone call that passed through a facility or communications network device. A CDR is the automated equivalent of a paper toll ticket that was written and timed by operators to track long-distance calls for billing in a manual telephone exchange.

A CDR is conventionally composed of fields that describe the communications exchange. Examples of fields include, e.g., but not limited to, a phone number (ANI) making a call (i.e., calling party), a phone number receiving the call (i.e., called party), time when the call started (e.g., date and time), how long in time the call lasted (e.g., duration), the phone number to be charged for the call (e.g., regular, private, collect, or intercarrier, etc.), an identifier of the telephone exchange writing the record, a sequence number identifying the record, additional digits on the called number used to route or charge the call (e.g., long distance, international, area code, operator-assisted, etc.), the result of the call (e.g., whether it was answered, completed, busy, etc.), the route by which the call entered the exchange, the route by which the call left the exchange, a call type (e.g., voice, short message service (SMS), VoIP, etc.), and any fault condition encountered, etc.

Conventionally, an exchange switch manufacturer may decide which information is captured and/or tracked and formatting of the information. Standards have developed for intercarrier billing. Examples of different information provided by vendors may include, e.g., but not limited to, sending a timestamp of an end of a call instead of duration, voice-only machines may not send call type, and some private branch exchange (PBX) devices may not send the calling party, etc.

### Per Call Measurement Data (PCMD)

A conventional technique for collecting mobile communications network operational parameters is known as the per call measurement data (PCMD) method. In this technique, a wireless network communications network takes periodic measurements that include signal strength from the mobile phone and stores them in a central server. Latitude and longitude may then be determined by triangulating based on the known locations and timing offsets of the cellular towers of the mobile communications network. In such a method, the location of where the measurements are taken can be inaccurate due the limitations that result from using timing triangulation. Further, the location of the mobile device can be determined when the mobile station is seen by a plurality of cellular towers.

### Exemplary Operating Scenario:

According to an exemplary embodiment, exemplary INrange Analytics, available from TEOCO Corporation of Fairfax, Va. may use data gathered from exemplary Voice and Data detail records (xDRs) and use the Tower ID to estimate a general location of the mobile device by time of day. In this exemplary embodiment, global positioning system (GPS) location sensing is not used to estimate the mobile device location. According to an exemplary embodiment, the xDRs may then be stored at a detail level for an exemplary predefined period of approximately a 60 day period. Over the exemplary, but non-limiting 60 day period, a pattern may emerge that shows the general location of the exemplary mobile device on a series of different days and at different hours. According to other exemplary embodiments, a period of one week, or two weeks, or greater may also be alternatively used as the predefined time period. The pattern that emerges from the historical data upon analytical processing, may them be summarized to provide a confidence score by the computer processor to predict where the device will be at a given weekday and time in the future.

According to an exemplary embodiment, the predictive aspect of obtaining an anticipated location at a given time period in the future, according to an exemplary embodiment can be performed by an exemplary combination of analyzing measurement data to obtain a precise location of a device, geolocating the device, performing exemplary cluster analysis analyzing geographical location clustering of device location history samples, exemplary timing analysis involving day of week and time of day analysis, and a scoring history to obtain a prediction of a predicted device location and time period for a device, in the future.

According to an exemplary embodiment, the accuracy of the pattern may be enhanced for accuracy by the use of RAN data and or GPS or other location based sensing data.

### Projected Exemplary Usage:

According to an exemplary embodiment, an exemplary INrange Analytics may provide exemplary wireless Global Service Providers (GSPs), or other carriers, a capability to create a new revenue stream based on selling services enabled by analytical computer processing including predicting where mobile devices will be at a time period in the future based on historical predictive analysis. Through the use of exemplary communication technologies including, in an exemplary, but not limiting embodiment exemplary simple message system (SMS) and/or electronic mail (Email), GSPs may enable creation and delivery and/or sell exemplary offerings such as, e.g. but not limited to, exemplary electronic coupons to merchants and/or others interested in driving traffic to the merchants' stores and/or businesses' products offerings. The GSP may deliver the coupons based on an exemplary method as described above and/or may be combined with conventional Subscriber demographic data and psychographic data analysis. The result may include sending coupons to exemplary mobile devices based on where the mobile device has been predicted to be in the future, as opposed to where the mobile device is currently.

In this exemplary usage, the wireless GSP does not disclose any Subscriber information beyond its Network and can choose to have customers opt-in or opt-out of such advertising services based on preferences, according to one exemplary embodiment. The value of the exemplary coupons and/or offerings is controlled by the merchant and the merchant may provide a point of sale (POS) feed back to the GSP for effectiveness reporting.

According to an exemplary embodiment of the present invention, an exemplary system and/or method may innovatively depart from conventional methods by collecting, analyzing and developing a location history of all wireless subscribers for a given carrier, analyzing a given subscriber's samples by cluster, analyzing time ranges by cluster over time using multiple data sources to reasonably predict a future location and time of where the subscriber will be. The predictive scoring may allow service providers to enable opt-in and anonymous monetization programs based on the predictive information. Advantageously, the data may be a massively high volume level (e.g., an entire database of tower location data including e.g., voice and data, call detail record (CDR) analysis, collecting and analyzing detailed call data, not only when call is occurring, but also per call measurement data (e.g., analysis of device reporting regarding relative strength of proximate towers, to analyze highly precise locations of a user's device) and may be mined and/or analyzed (including, e.g., but not limited to, geolocating a call, performing cluster analysis (e.g., an exemplary 2 to 5 exemplary locations or geographic areas, or places, that the user device appears to be observed within) of device location samples, and performing time range analysis, analyzing start and end times, pattern tracking to obtain probabilistic data of future location movement and time ranges, e.g., predicting probabilistically a subscriber device's future location and time period range, to enable providing efficient targeting of probabilistically reliable location based promotional content (e.g., advertising, coupons, marketing, offers, publicity, etc.), or other sources of monetization of the location information (e.g., crime solving, etc.) to the subscriber device, and/or tracking of the device. The ad content, according to an exemplary embodiment may be delivered by the carrier, or alternatively by the carrier's delegate. Exemplary advertising campaigns or other campaigns may be specifically defined by receiving an exemplary campaign specification. According to one exemplary embodiment, information of a predictive location of a device may be used to target timely targeting offers and promotions to a user. The detailed call information may be used to track and analyze and predict other information and may be used to provide additional services, including, according to another exemplary embodiment, other services based on the predictive data may be offered such as, e.g., tracking of a lost, misplaced, or stolen device.

While various embodiments of the present invention have been described above, it should be understood that they have been presented by way of example only, and not limitation. Thus, the breadth and scope of the present invention should not be limited by any of the above-described exemplary embodiments, but should instead be defined only in accordance with the following claims and their equivalents. It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. A computer-implemented method comprising:
a) receiving or collecting, by at least one processor, at least one geolocated subscriber event data; wherein said geolocated subscriber event data comprises at least one of:
i) at least one said geolocated subscriber event data derived from at least one communications tower location information;
ii) at least one said geolocated subscriber event data derived from at least one call detail record (CDR) data; or
iii) at least one said geolocated subscriber event data from at least one global positioning system sensor (GPS);
b) determining historic location information for each of a plurality of devices of a communications service provider (CSP), said determining comprising:
i) receiving said historic location information of said each of said plurality of devices by geolocation;
ii) identifying at least one frequented location of at least one subscriber based on of said historic location information; and
iii) determining at least one time range for said each of said at least one frequented location of said historic location information; and
c) predicting probabilistically at least one expected location and at least one expected time period for said each of said plurality of devices.

2. The method according to claim 1, further comprising at least one of:
d) targeting at least one offering based on said predicting;
e) providing at least one offering to said at least one given device based on said predicting; or
f) monetizing at least one offering based on said predicting.

3. The method according to claim 2, wherein said at least one offering comprises at least one of: a promotion, a coupon, an advertisement, a time based offering, a voucher, a discount, an electronic message, electronic mail (email), facsimile (fax), a simple message system (SMS), a multimedia message system (MMS), a gift certificate, an expiring deal, a daily deal, a group coupon, a Groupon offer, a LivingSocial offer, an electronic commerce offering, an Amazon offer, a social network communication, a social media post, a tweet, a Facebook post, a Pinterest pin, a bricks and mortar offering, a traditional coupon, or a targeted promotion.

4. The method according to claim 1, wherein said communications service provider comprises at least one of: a wireless communications service provider; or a global communications service provider.

5. The method according to claim 1, wherein said analyzing said at least one cluster comprises analyzing and identifying a probability of a cluster comprising at least one of:
at least one home;
at least one work;
at least one vacation home;
at least one school;
at least one geographic region;
at least one county, city, town, village, or municipality;
at least one road;
at least one path;
at least one series of directions taken;
at least one block; or
at least one building.

6. The method according to claim 1, wherein said analyzing said at least one time range comprises analyzing at least one of:
at least one start time;
at least one end time; or
at least one duration.

7. The method according to claim 1, wherein said probabilistically predicting of said (c) comprises predicting at least one of:
at least one expected behavior;
at least one expected path to be taken;
at least one expected action;
at least one expected desire;
at least one expected need;
at least one expected behavior; or
at least one expected next location for the said each given device.

8. The method according to claim 1, wherein said communications tower location information of (a) (i) comprises at least one of:
detailed call detail record (CDR) data;
simple message system (SMS) record data;
data session record data;
wireless network data;
wireless fidelity (WiFi) hotspot measurement data;
measurement data from a radio access network (RAN);
per call measurement data (PCMD);
data analyzing relative strength of tower communication before, during and after a call; or
a device's location based information.

9. The method according to claim 1, further comprising at least one of:
generating a target subscriber list for at least one campaign; or
providing a subscriber list to a carrier for delivery of at least one of an offer, content, or an advertisement.

10. A computer implemented method comprising:
a) collecting, by at least one computer processor, at least one event record of at least one event from at least one carrier network,
wherein said at least one event record comprises at least one of:
at least one call detail record (CDR) from a switch;
at least one simple message system (SMS) record from a switch;
at least one data session record from an authentication server;
at least one said geolocated subscriber event data from at least one global positioning system sensor (GPS);
at least one measurement data from a wireless network; or
at least one measurement data from a radio access network (RAN);
b) calculating at least one location for each of said at least one event,
wherein said calculating said at least one location of said at least one event comprises at least one of:
looking up at least one serving communication tower location;
geolocating said at least one event; or
applying at least one geolocation algorithm to said at least one measurement data, comprising at least one of:
triangulating;
converting measurement data to location data;
determining a center and surrounding radius of a location;
c) storing at least a predefined number of days of at least one located event data comprising said at least one event and said at least one location in at least one data repository; and
d) calculating and storing at least one frequented location for each subscriber.

11. The method according to claim 10, wherein said storing of said predefined number of days of said (c) comprises at least one of:
storing at least 60 days or at least 90 days of said at least one located event data;
storing at least a week of said at least one located event data;
storing at least two weeks of said at least one located event data; or
storing at least two or more weeks of said at least one located event data.

12. The method according to claim 10, wherein said calculating of said (d) comprises at least one of:
calculating periodically said at least one frequented location for each subscriber; or
using a cluster analysis to group located events and identify said at least one frequented location, wherein said cluster analysis comprises at least one of:
determining a center location of a cluster;
determining an area about a cluster location; or
determining a radius about a cluster.

13. The method according to claim 10, wherein said calculating of said (d) comprises at least one of:
calculating and storing at least one predicted day of week and time of day range for each of said at least one frequented location for each subscriber; or
calculating and storing at least one location score that represents a probability of a subscriber being in a given one of said at least one frequented location during a typical date and time period, wherein said probability comprises at least one of:
statistical analysis;
calculating a score;
calculating a mean and standard deviation; or
probability analysis.

14. The method according to claim 10, further comprising:
generating a target subscriber list for at least one specific ad campaign.

15. The method according to claim 14, wherein said generating comprises at least one of:
at least one ad campaign specified based on at least one of:
at least one predicted location of the subscriber;
at least one location score of the subscriber; or
at least one subscriber demographic information provided by the carrier.

16. The method according to claim 15, wherein said at least one subscriber demographic data comprises at least one of:
a gender; or
an age.

17. The method according to claim 14, further comprising:
providing said target subscriber list to the at least one carrier for delivery of at least one of:
at least one communication;
at least one ad;
at least one notification;
at least one alert;
at least one promotion;
at least one coupon; or
at least one offer.

18. The method according to claim 17, wherein at least one of:
said subscriber information of subscribers on said subscriber list is not exposed to an advertiser; or
said information is maintained in private.

19. A system comprising:
at least one memory;
at least one processor coupled to said at least one memory, said processor adapted to collect at least one event record of at least one event from at least one carrier network,
wherein said at least one event record comprises at least one of:
at least one call detail record (CDR) from a switch;
at least one simple message system (SMS) record from a switch;
at least one data session record from an authentication server;
at least one global positioning system (GPS) location;
at least one measurement data from a wireless network; or
at least one measurement data from a radio access network (RAN);
said processor adapted to calculate at least one location for each of said at least one event,
wherein said calculation of said at least one location of said at least one event comprises at least one of:
the processor adapted to look up at least one serving communication tower location;
the processor adapted to geolocate said at least one event; or
the processor adapted to apply at least one geolocation algorithm to said at least one measurement data, comprising at least one of:
the processor adapted to triangulate;
the processor adapted to convert measurement data to location data;
the processor adapted to determine a center and surrounding radius of a location;
the processor adapted to store at least a predefined number of days of at least one located event data comprising said at least one event and said at least one location in at least one data repository; and
the processor adapted to calculate and store at least one frequented location for each subscriber.

20. A nontransitory computer program product embodied on a computer readable medium, said computer program product comprising program logic, which when executed on a processor may execute a method comprising:
a) collecting at least one event record of at least one event from at least one carrier network,
wherein said at least one event record comprises at least one of:
at least one call detail record (CDR) from a switch;
at least one simple message system (SMS) record from a switch;
at least one data session record from an authentication server;
at least one location from a global positioning system (GPS);
at least one measurement data from a wireless network; or
at least one measurement data from a radio access network (RAN);
b) calculating at least one location for each of said at least one event,
wherein said calculating said at least one location of said at least one event comprises at least one of:
looking up at least one serving communication tower location;
geolocating said at least one event; or
applying at least one geolocation algorithm to said at least one measurement data, comprising at least one of:
triangulating;
converting measurement data to location data;
determining a center and surrounding radius of a location;
c) storing at least a predefined number of days of at least one located event data comprising said at least one event and said at least one location in at least one data repository; and
d) calculating and storing at least one frequented location for each subscriber.

21. A computer-implemented method comprising:
a) receiving or collecting, by at least one processor, at least one geolocated event data for at least one subscriber;
b) identifying, by the at least one processor, at least one frequented location of a given one of the at least one subscriber using said at least one geolocated event data;
d) determining, by the at least one processor, at least one time period during which the given one of the at least one subscriber was at least one of entering, within or leaving at least one of said at least one frequented location; and
e) predicting, by the at least one processor, for the given one of the at least one subscriber, at least one predicted location and at least one predicted time period; and
f) providing, by the at least one processor, said at least one predicted location and said at least one predicted time period.

22. The method according to claim 21, wherein said (b) of said identifying said at least one frequented location comprises:
receiving, by the at least one processor, a block size;
receiving, by the at least one processor, a superblock size, wherein said superblock size is a multiple of said block size;
creating, by the at least one processor, a grid whose cell size is said block size, wherein said grid covers an entire geographic area of said at least one said geolocated event data;
determining, by the at least one processor, a number of at least one geolocated event in each and every one of said superblocks that aligns with or snaps to said grid and is completely contained in said grid;
creating, by the at least one processor, a list of said at least one superblock with an associated one of said number of said at least one geolocated event;
ordering, by the at least one processor, said list of said at least one superblock into an ordered list, in descending order by value of said associated one of said number of said at least one geolocated event; and
eliminating, by the at least one processor, any of said at least one superblock of said ordered list of said at least one superblocks, that shares at least one block of another of said at least one superblock that is higher on said ordered list; and
eliminating, by the at least one processor, any superblock of any remaining of said at least one superblocks that has a value of said associated one of said number of said at least one geolocated event, that falls below a threshold number of events.

23. The method according to claim 21, wherein said geolocated event data comprises at least one of:
i) at least one said geolocated subscriber event data derived from at least one per call measurement data (PCMD);
ii) at least one said geolocated subscriber event data derived from at least one call detail record (CDR) data; or
iii) at least one said geolocated subscriber event data derived from at least one global positioning system (GPS) data.
